(19) United States
(12) Patent Application Publication
(10) Pub. No.: US 2025/0142601 A1
(43) Pub. Date: May 1, 2025

(54) ADVANCED COOPERATIVE USER EQUIPMENT UPDATE

(71) Applicant: QUALCOMM Incorporated, San Diego, CA (US)

(72) Inventors: Fang YUAN, Beijing (CN); Aleksandar DAMNJANOVIC, Del Mar, CA (US); Luanxia YANG, Beijing (CN); Wooseok NAM, San Diego, CA (US); Mostafa KHOSHNEVISAN, San Diego, CA (US); Tao LUO, San Diego, CA (US); Rajat PRAKASH, San Diego, CA (US); Xiaoxia ZHANG, San Diego, CA (US)

(21) Appl. No.: 18/684,077

(22) PCT Filed: Oct. 29, 2021
(86) PCT No.: PCT/CN2021/127266

§ 371 Date: Feb. 15, 2024

(51) Int. Cl. H04W 72/40; H04B 17/318; H04W 76/28

(52) U.S. Cl. CPC H04W 72/40; H04B 17/328; H04W 76/28

(57) ABSTRACT

Wireless communications systems and methods related to UE cooperation are provided. A base station (BS) may assist a UE in cooperating with other UEs. A UE may transmit a cooperative UE update request to aBS, indicating a number of candidate cooperative UE sets. The UE may also transmit information to the BS about the candidate cooperative UE sets such as UE capability information, location information, and channel measurements. Additional measurements maybe requested by the BS. The BS may use the information from the UEs together with BS-side information such as configuration information and TRP information in order to determine which of the candidate cooperative UE sets is preferred. The BS may then configure and communicate with selected cooperative UE set.

### TECHNICAL FIELD

This application relates to wireless communication devices, systems, and methods, and more particularly to devices, systems, and methods for facilitating UE cooperation.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like).

A wireless communication network may include a number of base stations (BSs) that can support communication for a number of user equipment (UEs). A user equipment (UE) may communicate with a base station (BS) via the downlink and uplink. In some instances, a UE may further communicate with one or more other UEs via a sidelink communication. In some instances, a sidelink connection between UEs may be used to provide a UE with an indirect communication link to a BS to take advantage of underutilized resources at the UEs and/or BS(s), referred to as UE cooperation. Existing approaches are limited in how UEs may discover and cooperate with each other, due to such issues as different sidelink configurations at different UEs that prevent discovery of each other, separate information exchange between different UEs and a BS, and/or one or more UEs entering power saving mode at cycles unknown to other UEs. There are also circumstances where a UE discovers multiple candidate cooperative UEs. Optimum UE cooperation performance may not be available without access to, and use of, information available at the BS side instead of at the UE. Therefore, there exists a need for improved methods of discovering and selecting UEs in order to establish UE cooperation.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

According to one aspect of the present disclosure, a user equipment (UE) comprises a transceiver configured to transmit, to a base station (BS), a cooperative UE update request comprising a plurality of candidate cooperative UE sets and a UE capability set associated with the plurality of candidate cooperative UE sets and receive, from the BS, an indication of a cooperative UE set comprising at least one of the plurality of candidate cooperative UE sets. The UE further comprises a processor configured to connect, via a sidelink channel, to at least one cooperative UE associated with the cooperative UE set and the transceiver is further configured to communicate, with the BS, using the cooperative UE set.

According to another aspect of the present disclosure, a base station (BS) comprises a transceiver configured to receive, from a user equipment (UE), a cooperative UE update request comprising a plurality of candidate cooperative UE sets and a UE capability set associated with the plurality of candidate cooperative UE sets; transmit, to the UE, an indication of a cooperative UE set comprising at least one of the plurality of candidate cooperative UE sets based on the UE capability set and a BS-side information set; and communicate using the cooperative UE set.

According to another aspect of the present disclosure, a method of wireless communication comprises transmitting, by a user equipment (UE) to a base station (BS), a cooperative UE update request comprising a plurality of candidate cooperative UE sets and a UE capability set associated with the plurality of candidate cooperative UE sets; receiving, by the UE from the BS, an indication of a cooperative UE set comprising at least one of the plurality of candidate cooperative UE sets; connecting, by the UE via a sidelink channel, to at least one cooperative UE associated with the cooperative UE set; and communicating, by the UE with the BS, using the cooperative UE set.

According to another aspect of the present disclosure, a method of wireless communication comprises receiving, by a base station (BS) from a user equipment (UE), a cooperative UE update request comprising a plurality of candidate cooperative UE sets and a UE capability set associated with the plurality of candidate cooperative UE sets; transmitting, by the BS to the UE, an indication of a cooperative UE set comprising at least one of the plurality of candidate cooperative UE sets based on the UE capability set and a BS-side information set; and communicating, by the BS, using the cooperative UE set.

Other aspects and features aspect of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2A is a diagram illustrating a network with UEs operating without cooperation according to some aspects of the present disclosure.

FIG. 2B is a diagram illustrating a network with UEs operating with cooperation according to some aspects of the present disclosure.

FIG. 3 illustrates an exemplary wireless communication network according to some aspects of the present disclosure.

FIG. 4 illustrates an exemplary wireless communication network according to some aspects of the present disclosure.

FIG. 5 is a block diagram of an exemplary base station according to some aspects of the present disclosure.

FIG. 6 is a block diagram of an exemplary user equipment according to some aspects of the present disclosure.

FIGS. 7-11 are exemplary communication protocol diagrams according to some aspects of the present disclosure.

FIGS. 12-15 are exemplary flow diagrams according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 702.11, IEEE 702.16, IEEE 702.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond, and in particular to the development of UE cooperation.

In some networks, a UE may communicate with one or more other UEs via a sidelink communication. A sidelink connection between UEs may be used to provide a UE with an indirect communication link to a BS, referred to as UE cooperation. Some networks rely on the UEs discovering each other without assistance from a BS. A UE may discover a number of candidate cooperative UEs with which it could potentially connect. It may be desirable that the UE knows which candidate UEs are the best candidates for cooperation, which may be based on a number of criteria.

In some aspects of the present disclosure, a BS may assist a target UE in determining a preferred cooperative UE set for UE cooperation. The BS may use a number of criteria in order to make the determination. For example, the BS may consider UE-side information such as the capabilities of each candidate UE set, UE location information, and sidelink channel measurements. The BS may also consider BS-side information such as discontinuous reception (DRX) configurations to each candidate UE, transmit beam separation at the BS for different candidate UEs, inter-UE interference between candidate UEs, transmission and reception point (TRP) sets, TRP on/off status, and/or inter-TRP backhaul conditions (to name just a few examples). Once the BS has determined a preferred cooperative UE set based on the considered information, the BS indicates the cooperative UE set to the target UE and reconfigures the UE for cooperation. At that point the UE set may cooperatively communicate with the network.

Some information, such as the BS-side information, may be available to the BS independently of the target UE passing the information to the BS, for example by virtue of the BS being in communication with and configuring the cooperative UEs. When a target UE sends a cooperative UE update request indicating candidate cooperative UE sets to the BS, it may include UE-side information with the request. The cooperative UE update request may include UE capability information and other UE-side information. In some other aspects, UE-side information may be sent by the UE separately from UE capability information, such as in response to a request for information by the BS. For example, the BS may request capability information and separately request other UE-side information from the UE. In other examples, the BS may receive capability information and other UE-side information based on one request.

The BS may also trigger additional measurements in order to aid in the determination of the preferred cooperative UE set. For example, the BS may explicitly configure CSI measurements and reports for the candidate cooperative UEs. CSI reports may be communicated back to the BS either directly from the candidate cooperative UEs or indirectly via the target UE.

In some aspects, the BS considers BS-side information together with UE-side information in order to make a determination. Information may be used together in various ways. For example, different information may be weighted differently to arrive at a relative score which is used to determine the preferred UE set. In some other aspects, the location of a UE may be considered together with information about the status of a nearby transmission/reception point (TRP). For example, a candidate cooperative UE which is near a TRP which is currently turned off may be considered preferential for use in cooperation if the BS is able to turn on that TRP. Other examples are discussed in more detail herein with reference to the figures.

Aspects of the present disclosure provide several benefits. For example, by having UEs provide information to the BS, together with BS-side information that is unavailable otherwise to the UE(s), the BS may have a more complete picture of the criteria that may impact the relative effectiveness of different candidate cooperative UE sets. This may lead to the BS being able to make a more optimal decision about which UE set to configure for cooperation. Further, aspects of the present disclosure reduce the latency for setting up an optimal cooperative UE set from multiple candidate cooperative UE sets. By triggering additional measurements, the BS may also gather additional information that would not otherwise be available to assist in the decision. BS assistance in cooperation between UEs may result in more complete network resource utilization. By establishing cooperative UE communication, the network may benefit from lower latency, higher throughput communication between a UE and a BS.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer.

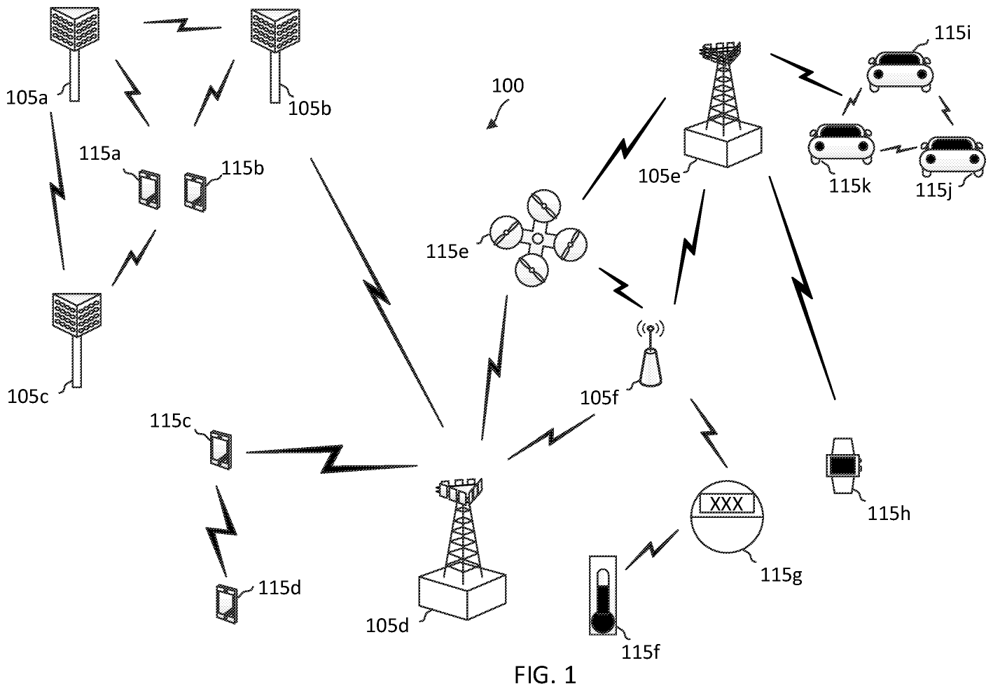

FIG. 1 illustrates a wireless communication network 100 according to some aspects of the present disclosure. The network 100 may be a 5G network, an LTE network, or any suitable cellular network and/or combinations thereof. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for sidelink communication, and for access to the network 100. A UE 115 may be able to communicate with other UEs 115 or wireless nodes, or any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such asV2V, V2X, V2P, and/or C-V2X communications between a UE 115i, 115j, or 115k and other UEs 115, and/or vehicle-to-infrastructure (V2I) communications between a UE 115i, 115j, or 115k and one or more other wireless nodes, including through the use of sidelink communications in accordance with the present disclosure.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 (or UEs 115 or other wireless nodes, in sidelink communication scenarios) can assign or schedule transmission resources (e.g., in the form of time-frequency resource blocks (RB)) for downlink (DL) and uplink (UL) transmissions (or sidelink transmissions). DL may refer to the transmission direction from a BS 105 to a UE 115, whereas UL may refer to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 (or another UE or wireless node) to estimate a UL channel (or sidelink channel). Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. In some other aspects, the wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the BSs 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions (e.g., sidelink communications), among other examples.

The BSs 105 (or UEs 115 in sidelink communication) can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105 or from another wireless node in the network (e.g., another UE 115 in sidelink communication). The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a back-off indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., bandwidth parts). A BS 105 may dynamically assign a UE 115 to operate over a certain BWP (e.g., a certain part of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

Although much of the description of the network 100 above is in the context of communication between UEs 115 and BSs 105, it will be understood that the mechanisms, elements, structures, and protocols described above can be performed between UEs 115 or wireless nodes in a sidelink communication scenario. For example, in some aspects, the radio frame structures, channels, signals, scheduling procedures, and/or connection techniques (e.g., HARQ) may be performed between UEs 115/wireless nodes, rather than between a BS 105 and a UE 115.

Sidelink communications refers to the communications among user equipment devices (e.g., UEs 115i, 115j, 115k) without tunneling through a BS 105 and/or a core network. Sidelink communication can be communicated over a physical sidelink control channel (PSCCH) and a physical sidelink shared channel (PSSCH). The PSCCH and PSSCH are analogous to a physical downlink control channel (PDCCH) and a physical downlink shared channel (PDSCH) in downlink (DL) communication between a BS 105 and a UE 115, as described above. For instance, the PSCCH may carry sidelink control information (SCI) and the PSSCH may carry sidelink data (e.g., user data). Each PSCCH is associated with a corresponding PSSCH, where SCI in a PSCCH may carry reservation and/or scheduling information for sidelink data transmission in the associated PSSCH.

By utilizing sidelink communication, a UE 115 may communicate with another UE 115 independent of BS 105, and/or cooperate with another UE 115 to communicate with a BS 105. For example, the UEs 115 may communicate via a cooperative sidelink using unlicensed spectrum, which may ensure all licensed spectrum remains available to the network 100 (while, in other examples, licensed or a combination of licensed and unlicensed spectrum may be used). In this way network resources may be more fully utilized, and/or a UE 115 which has trouble reliably communicating with a BS 105 may use its resources to communicate via the cooperative UE 115 which may be a more reliable link.

A BS 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a BS 105 multiple times in different directions. For example, the BS 105 may transmit a signal according to different beamforming weight sets associated with different directions of transmission. Transmissions in different beam directions may be used to identify (e.g., by a transmitting device, such as a BS 105, or by a receiving device, such as UE 115) a beam direction for later transmission or reception by the BS 105. Some signals may be transmitted in a single beam direction (e.g., data associated with a particular receiving device). In some examples, the beam direction associated with transmissions along a single beam direction may be determined based on a signal that was transmitted in one or more beam directions. For example, a UE 115 may receive one or more of the signals transmitted by the BS 105 in different directions and may report to the BS 105 an indication of the signal that the UE 115 received with a highest signal quality or an otherwise acceptable signal quality.

In some examples, transmissions by a device (e.g., by a BS 105 or a UE 115) may be performed using multiple beam directions, and the device may use a combination of digital precoding or radio frequency beamforming to generate a combined beam for transmission (e.g., from a BS 105 to a UE 115). The UE 115 may report feedback that indicates precoding weights for one or more beam directions, and the feedback may correspond to a configured number of beams across a system bandwidth or one or more sub-bands. The BS 105 may transmit a reference signal (e.g., a CRS, a CSI-RS, etc.), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a BS 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the BS 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

Utilizing sidelink communications can enable UEs 115 to cooperate together to communicate with a BS 105 as a single entity (e.g., a single RRC entity). From the BS 105 perspective, when UE cooperation is implemented the BS 105 may consider multiple antenna panels associated with different UEs 115 to be a part of the same virtual UE (which also may be referred to as a distributed unit, single entity, or disaggregated UE). The virtual UE may be configured as a single RRC entity. In such a configuration, the network may not care which UE 115 a communication is being received from or transmitted to, but instead may recognize communications as coming from or being sent to a single entity.

The two or more UEs 115 may communicate via sidelink communication links to transfer the information received from the BS 105, and/or to be transmitted to the BS 105, between one another. For example, a BS 105 may transmit a message to an antenna panel of a first UE 115 although the message is intended for a second UE 115 (e.g., a target UE). The process of communicating the information may be referred to as UE cooperation. For example, the first UE 115 may recognize that the received message is intended for the second UE 115 and may transmit or relay the message to the second UE 115 via a sidelink. UE cooperation may also be performed with more than two UEs 115 in a set.

A BS 105 may assist a target UE 115 in determining a preferred cooperative UE set for UE cooperation. A cooperative UE set includes the target UE 115 and any additional cooperative UE. For example, where “UE0” is the target UE, some example UE sets are {UE0, UE1}, {UE0, UE2}, and {UE0, UE1, UE2}. The BS 105 may use a number of criteria in order to make the determination. For example, the BS 105 may consider UE-side information such as one or more of the capabilities of each candidate UE set, UE 115 location information, and sidelink channel measurements. The BS 105 may also, or alternatively, consider BS-side information such as discontinuous reception (DRX) configurations, transmit beam separation at the BS 105, inter-UE interference, transmission and reception point (TRP) sets, TRP on/off status, and/or inter-TRP backhaul conditions (to name just a few examples). Once the BS 105 has determined a preferred cooperative UE set based on any of the noted information, the BS 105 indicates the determined cooperative UE set to the target UE 115 and reconfigures the UE 115 for cooperation. At that point the UE set may cooperatively communicate with the network.

Some information, such as the BS-side information, may be available to the BS 105 independently of the target UE 115 passing the information to the BS 105, for example by virtue of the BS 105 being in communication with and configuring the cooperative UEs 115. When a target UE 115 sends a cooperative UE update request indicating candidate cooperative UE sets to the BS 105, the target UE 115 may include UE-side information with the request. The cooperative UE update request may include UE capability information and other UE-side information. In some aspects, UE-side information may be sent by the UE 115 separately from UE capability information, such as in response to a request for information by the BS 105. For example, the BS 105 may request capability information and separately request other UE-side information from the UE 115. In other examples, the BS 105 may receive capability information and other UE-side information based on one request.

While the BS 105 may make a determination of which candidate cooperate UE set to use, in some examples the BS 105 may also trigger additional measurements in order to aid in the determination of the preferred UE set. For example, the BS 105 may explicitly configure CSI measurements and reports for the candidate cooperative UEs 115. CSI reports may be communicated back to the BS 105 either directly from the candidate cooperative UEs 115 or indirectly via the target UE 115. However received, the BS 105 may make the determination of preferred UE once the BS 105 has the additional information from those CSI reports together with any other information considered at the BS 105 for the determination.

In some aspects, the BS 105 considers BS-side information together with UE-side information in order to make a determination. Information may be used together in various ways, for example different information may be weighted differently to arrive at a relative score which is used to determine the preferred UE set. As another example, the location of a UE 115 may be considered together with information about the status of a nearby TRP that is known to the BS 105 but not a target UE 115. A candidate cooperative UE 115 which is within range of a currently-off TRP may be considered preferential for use in cooperation if the BS 105 is able to turn on that TRP.

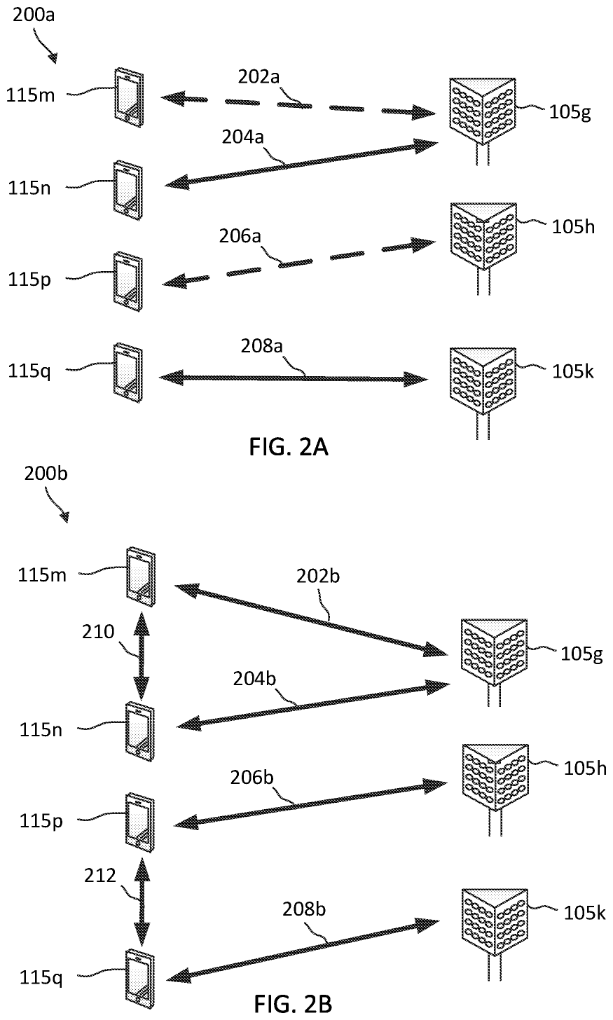

FIG. 2A is a diagram illustrating a network 200a with UEs 115 operating without cooperation. In the illustrated example, BS 105g communicates with UE 115n via communication channel 204a. The communication channel 202a between BS 105g and UE 115m is unutilized (indicated by the dashed line), as UE 115m is attached but not actively communicating with BS 105g. Similarly, communication channel 206a is unutilized as UE 115p is not actively communicating with BS 105h. Finally, communication channel 208a is being used for communication between UE 115q and BS 105k. The unutilized communication channels 202a and 206a illustrate that network 200a is not fully utilizing its resources. As a result of the idle channels, the active UEs 115n and 115q are not able to take advantage of all spatial dimensions available in the network 200a (e.g., at least those spatial dimensions associated with unutilized channels 202a and 206a), and potentially are not utilizing their full RF capability (e.g., antennas), which may limit their communication throughput than would otherwise be available.

FIG. 2B is a diagram illustrating a network 200b with UEs 115 operating in cooperation with each other to communicate with one or more BSs 105. In contrast to network 200a, the resources of the network 200b are more fully utilized, by virtue of the UE cooperation. Active UE 115n may communicate with BS 105g using communication channel 204b. In addition, UE 115n may communicate via sidelink communication channel 210 (to UE 115m) to BS 105g. As UE 115m is not using communication channel 202b itself (between UE 115m and BS 105g), the UE 115m may use channel 202b to communicate with BS 105g on behalf of UE 115n. In contrast to communication channel 202a (FIG. 2A) that was unutilized in network 200a, communication channel 202b is utilized in network 200b, more fully realizing the capability of the network 200b. As another example, UE 115q may take advantage of unused capacity to communicate with the network 200b by indirectly communicating with BS 105h by communicating with UE 115p via sidelink communication channel 212 and UE 115p in turn communicating with BS 105h via communication channel 206b (relaying the information received via sidelink 212 from UE 115q). UE 115q may also directly communicate with BS 105k via communication channel 208b.

As these examples illustrate, UE cooperation may be used to increase throughput between a UE 115 and a single BS 105, or it may increase the throughput of a UE 115 by utilizing one or more additional BSs 105. For example, UE 115q may communicate (directly or indirectly) with BS 105h and BS 105k, and UE 115n may communicate (directly or indirectly) with BS 105g, both using cooperative UEs 115. Such cooperation may be useful in various scenarios. For example, while a UE such as UE 115n may have multiple antenna panels which could potentially be used to communicate via multiple channels simultaneously with BS 105g.

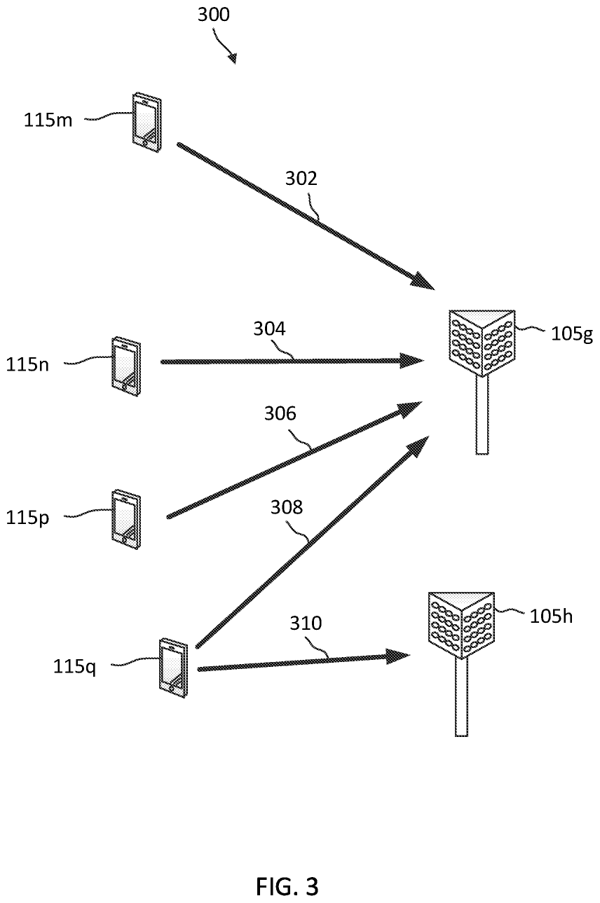

FIG. 3 is a diagram of a network 300 which illustrates an exemplary scenario where BS-assisted UE cooperation may be used. As illustrated, UE 115m is in communication with BS 105g via channel 302, UE 115n is in communication with BS 105g via channel 304, UE 115p is in communication with BS 105g via channel 306, and UE 115q is in communication with BS 105g via channel 308 and with BS 105h via channel 310.

As discussed above, a target UE, such as UE 115n may desire to use UE cooperation to improve communication with the network 300. UE 115n may discover UE 115m, UE 115p, and UE 115q. Early measurements before UE cooperation is enabled by the BS 105g. Early measurements may be made by the UEs 115 and information shared between these UEs 115 before they are configured for cooperation. The early measurements may be based on higher layer configurations which are not dedicated or optimized for the UE cooperation. UE 115n may then send a cooperative UE update request to BS 105g indicating a number of candidate cooperative UE sets. For example, the UE 115n may send as part of the request an indication of three possible sets, namely a first candidate cooperative UE set of {UE 115n, UE 115m}, a second candidate cooperative UE set of {UE 115n, UE 115p}, and a third candidate cooperative UE set of {UE 115n, UE 115q}. The information may include UE identifiers or panel identifiers (i.e., of one or more antenna panels of each UE 115). The cooperative UE update request may also include UE capability information about the UEs 115 and other UE-side information. BS 105g may use this information together with BS-side information to determine which cooperative UE set is preferred, and indicate that determined set to the UE 115n for implementation.

In some aspects, BS 105g may make the determination based on BS-side information. As just one example, the BS 105g may determine that the transmit beam separation between channels 304 and 308 is greater than the transmit beam separation between channels 304 and 306. This information may be used together with the received UE-side information, such as which beams are preferred by the UEs. The greater beam separation may tend to make the BS prefer UE 115q for cooperation with UE 115n. As a result, where the BS 105g makes its determination based on transmit beam separation, the BS 105g may select the third candidate cooperative UE set of {UE 115n, UE 115q}. Once selected, the BS 105g may transmit the determination to the UE 115n, for example by way of an RRC reconfiguration message for UE cooperation establishment.

In some aspects, BS 105h (which may be a TRP for sake of illustrating an example) may be currently turned off. BS 105g may be aware of this on/off status, and take this into account as BS-side information considered by the BS 105g. The UE 115n may learn or receive location information of the UE 115q as part of the UE-side information the UE 115n sends to the BS 105g. Therefore, BS 105g may know the location of UE 115q and recognize that UE 115q is near BS 105h (e.g., nearer to BS 105h than to BS 105g). The BS 105g may use this information (e.g., the location of the UE 115q and the status of the TRP illustrated as BS 105h) to determine that UE 115q is preferred for US cooperation via BS 105h. As part of this determination, the BS 105g may send a message to BS 105h to turn on as well as send the determined set to the UE 115n for implementation (e.g., by way of an RRC reconfiguration message, which provides dedicated configuration to enable UE cooperation). These are just a few examples. Further examples will be discussed with respect to other figures below.

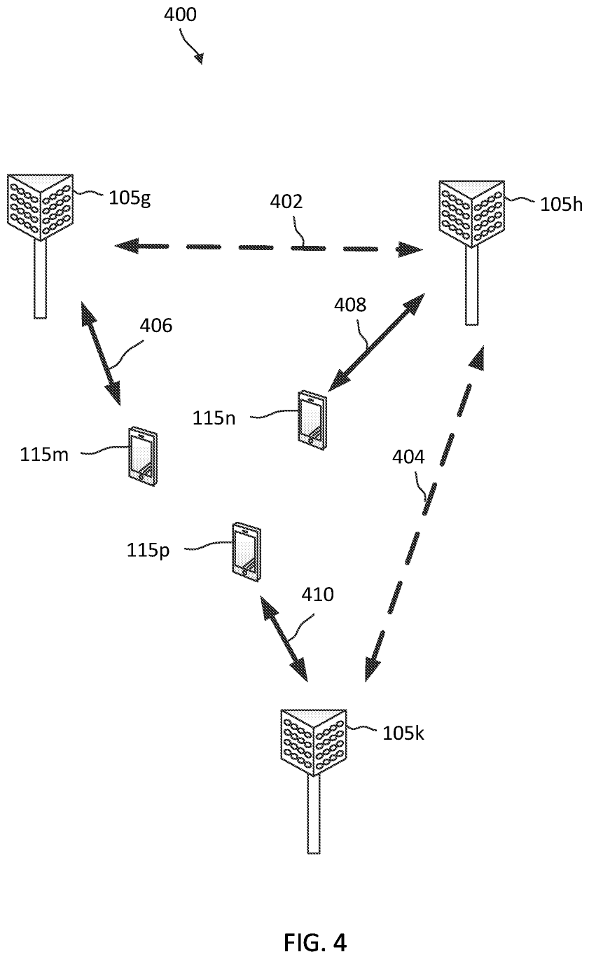

FIG. 4 is a diagram of a network 300 which illustrates another exemplary scenario where BS-assisted UE cooperation may be used. As illustrated, UE 115m is in communication with BS 105g via channel 406, UE 115n is in communication with BS 105h via channel 408, and UE 115p is in communication with BS 105k via channel 410. As discussed above, a target UE, such as UE 115n may desire to use UE cooperation to improve communication with the network 400. UE 115n may discover UE 115m and UE 115p. Early measurements may be made by the UEs 115 and information shared between these UEs 115 before they are configured for cooperation. The early measurements may be based on higher layer configurations which are not dedicated or optimized for the UE cooperation. With this information gathered, UE 115n may send a cooperative UE update request to BS 105h indicating candidate cooperative UE sets for the UE 115n to potentially use. The cooperative UE update request may also include UE capability information about the UEs 115 and other UE-side information. BS 105h may use this information together with BS-side information to determine which cooperative UE set is preferred.

In an example related to FIG. 4, UE-side information may include preferred synchronization signal block (SSB) and/or physical cell ID (PCI) for the UEs 115. The BS 105h may become aware of which beams and which BS or TRP the UEs 115 prefer to use to communicate based on this UE-side information (e.g. the TRP associated with the SSB and/or PCI). In this situation, the BS-side information that may be relevant includes inter-BS/inter-TRP link condition information. For example, BS 105h may measure the latency between BS 105g and BS 105h on link 402, and may also measure the latency between BS 105k and BS 105h on link 404. The BS 105h may prefer to use a candidate UE 115, for cooperation with UE 115n, that is preferentially communicating with whichever BS 105 from among BS 105g and BS 105k that has a lower latency link to BS 105h. For example, if link 402 has a lower latency than link 404, the BS 105h may use this BS-side information to determine to select the candidate cooperative UE set that includes UE 115m, as UE 115m is preferentially communicating with BS 105g as determined by the preferred SSB and/or PCI of UE 115m (as just an example).

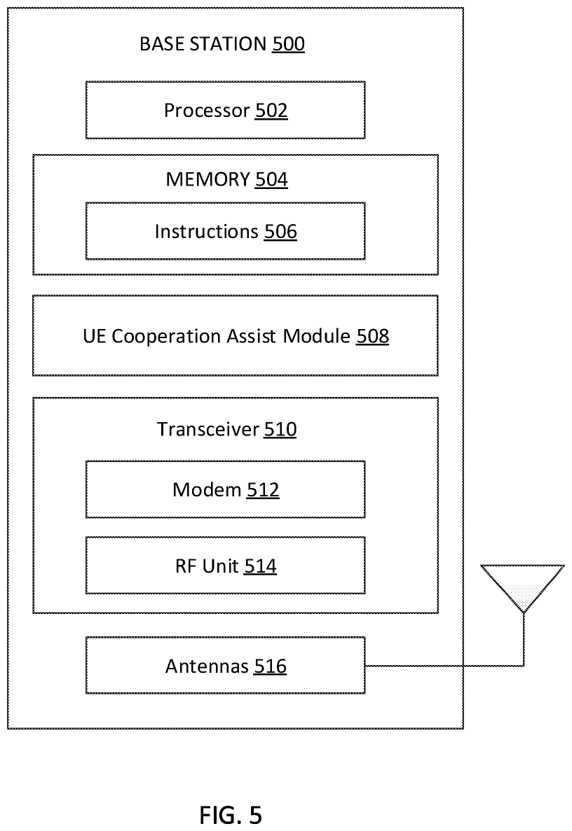

FIG. 5 is a block diagram of an exemplary BS 500 according to some aspects of the present disclosure. In some instances, the BS 500 may be a BS 105 in the network 100 as discussed above in FIG. 1. In some other instances, the BS 500 may be a BS 105g, BS 105h, and/or BS 105k discussed above with reference to FIGS. 2-4. A TRP may implement at least RF functionalities, but may also implement some baseband processing and/or protocol stack layer processing similar to a BS 105. As shown, the BS 500 may include a processor 502, a memory 504, a UE cooperation assist module 508, a transceiver 510 including a modem subsystem 512 and a RF unit 514, and one or more antennas 516. These elements may be coupled with one another. The term “coupled” may refer to directly or indirectly coupled or connected to one or more intervening elements. For instance, these elements may be in direct or indirect communication with each other, for example via one or more buses.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 1-15. Instructions 506 may also be referred to as program code. The program code may be for causing a wireless communication device to perform these operations, for example by causing one or more processors (such as processor 502) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The UE cooperation assist module 508 may perform functions described with reference to the other figures herein. The UE cooperation assist module 508 may receive a cooperative UE update request from a UE 115 indicating multiple candidate cooperative UE sets. The UE cooperation assist module 508 may determine which of the candidate cooperative UE sets is preferred (e.g., by taking advantage of the additional information available at the BS 500 that is not available to the UEs 115) and communicate that to the requesting UE 115. The determination may be based on a number of criteria, which may include UE-side information gathered from the target UE 115 and/or cooperative UEs 115, and may include BS-side information about the UEs 115 or other network information. UE-side information may be included in the cooperative UE update request and/or in a separate message from the UE 115. In some aspects, to aid the BS 500 in making a determination the UE cooperation assist module 508 requests additional information from the UE 115 and/or trigger additional measurements from the UE 115 or the candidate cooperative UEs 115.

UE-side information may include information about multiple candidate cooperative UE sets. UE sets may be indicated by UE IDs and/or panel IDs. UE-side information may also include UE capability information. UE capability information may include whether the UE or UE set is capable of single downlink control information (sDCI) or multiple downlink control information (mDCI) operation. UE capability information may also include whether the UE or UE set is capable of multiple transmission/reception point (multi-TRP) communication. Sidelink related information may also be included such as link latency between UEs in each candidate cooperative UE set. Other early measurements between UEs 115 (such as before cooperation) and information shared between UEs 115 may include UE measurements on a broadcasting channel, UE measurements on a dedicated (unicast) channel, UE position, preferred SSB indices, preferred beams/reference signals, UE physical cell ID (PCI), layer 1 (L1) reference signal received power (RSRP), and/or layer 3 (L3) RSRP, etc. In some examples, the BS 500 may use this information together with the BS-side information to determine which candidate cooperative UE set to select for the requesting UE 115.

The UE cooperation assist module 508 may also trigger additional measurements from the UEs 115 to aid the BS 500 in making the determination. These measurements may include UL measurements from the target or cooperative UEs 115, and DL measurements by the target or cooperative UEs 115. An example of a triggered UL measurement is a random access channel (RACH), or physical random access channel (PRACH) UL transmission. The UE cooperation assist module 508 may trigger a contention based PRACH transmission, and then the UE 115 may transmit a PRACH based on its measurement on the PRACH resource associated SSBs or CSI-RS. For example, the UE 115 may choose to transmit a PRACH in a PRACH occasion associated with a best measured SSB. In this way the UE cooperation assist module 508 may determine the best SSB for the UE 115. A contention free random access UL may be triggered, but a contention based random access (CBRA) communication may be used with less configuration information.

An example of a triggered DL measurement is an explicit DCI configuration for channel state information (CSI) measurement on the UE 115. The UE cooperation assist module 508 may reconfigure the UE 115 via RRC for CSI reports with respect to the cooperative UE, and trigger the CSI request via DCI. The UE cooperation assist module 508 may then send dedicated channel measurement resources (CMR) to the UE 115. A dedicated CSI report may be communicated by each UE 115 indicating which beams are preferred by each UE 115 based on the respective DL measurements. DL measurements by different UEs 115 may be communicated directly to the BS 500 by each UE 115, or may be communicated via the target UE 115 to the BS 500.

BS-side information available to the UE cooperation assist module 508 includes environment information such as stationary UEs available for UE cooperation, DRX configurations of various UEs 115, and sensing results from higher layers. For example, the BS 500 may perform sensing of UE position using mm Wave signal as radar. BS-side information may also include UE 115 TX beam information such as transmit beam separation at the BS 500. BS-side information may also include information about other BSs 500 or other TRPs. For example, TRP on/off status, and inter-TRP link condition (e.g. latency)

Of the above-described information, the UE cooperation assist module 508 may use all or a subset of the information in determining which cooperative UE set to select and configure for UE cooperation. In some aspects, each type of information may be mathematically weighted and summed to provide insight into the best cooperative UE set. In some aspects, information may be inter-related, such as the location of a UE 115 and the on/off status of a nearby TRP. As these types of information are inter-related, their relative weight may not be independent, as the relative importance of one depends on the status of the other. Other information that may be inter-related includes a preferred transmit beam of a UE 115 and the transmit beam separation between two UEs 115 preferred beams at the BS 500. These are just a few examples. The UE cooperation assist module 508 may consider all or a subset of the UE-side and BS-side information and determine which cooperative UE set to indicate to the target UE 115 should be used, and configure the UEs 115 as indicated (or indicate to the target UE 115 with the configuration).

As shown, the transceiver 510 may include the modem subsystem 512 and the RF unit 514. The transceiver 510 can be configured to communicate bi-directionally with other devices, such as the UEs 115 and/or another core network element. The modem subsystem 512 may be configured to modulate and/or encode data according to a MCS, e.g., a LDPC coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data (e.g., RRC configuration, CSI-RS resource configuration, CSI-RS report configuration, CSI-RSs, SSB beams, other control data including UE cooperation data and/or data traffic) from the modem subsystem 512 (on outbound transmissions) or of transmissions originating from another source such as a UE 115. The RF unit 514 may be further configured to perform analog beamforming in conjunction with the digital beamforming. Although shown as integrated together in transceiver 510, the modem subsystem 512 and/or the RF unit 514 may be separate devices that are coupled together at the BS 105 to enable the BS 105 to communicate with other devices.

The RF unit 514 may provide the modulated and/or processed data, e.g. data packets (or, more generally, data messages that may contain one or more data packets and other information), to the antennas 516 for transmission to one or more other devices. The antennas 516 may further receive data messages transmitted from other devices and provide the received data messages for processing and/or demodulation at the transceiver 510. The transceiver 510 may provide the demodulated and decoded data (e.g., messages including information sets, requests for information sets, and/or configuration requests) to the UE cooperation assist module 508 for processing. The antennas 516 may include multiple antennas of similar or different designs in order to sustain multiple transmission links. In some aspects, the antennas 516 may be in the form of one or more antenna panels or one or more antenna arrays each including a plurality of antenna elements that can be selectively configured with different gains and/or phases to generate a beam for transmission and/or reception.

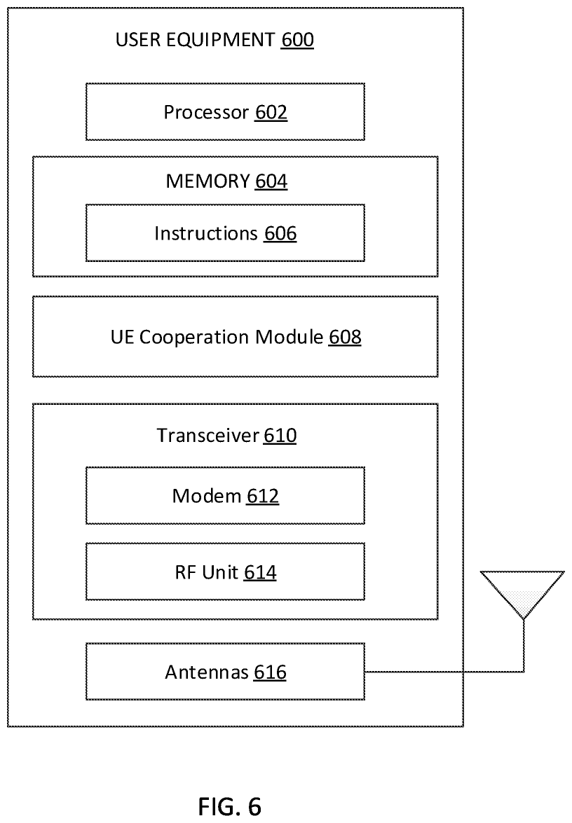

FIG. 6 is a block diagram of an exemplary UE 600 according to some aspects of the present disclosure. In some instances, the UE 600 may be a UE 115 as discussed above with respect to FIGS. 1-5. As shown, the UE 600 may include a processor 602, a memory 604, a UE cooperation module 608, a transceiver 610 including a modem subsystem 612 and a radio frequency (RF) unit 614, and one or more antennas 616. These elements may be coupled with one another. The term “coupled” may refer to directly or indirectly coupled or connected to one or more intervening elements. For instance, these elements may be in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 604 includes a non-transitory computer-readable medium. The memory 604 may store, or have recorded thereon, instructions 606. The instructions 606 may include instructions that, when executed by the processor 602, cause the processor 602 to perform the operations described herein with reference to the UEs 115 in connection with aspects of the present disclosure, for example, aspects of FIGS. 1-15. Instructions 606 may also be referred to as program code, which may be interpreted broadly to include any type of computer-readable statement(s) as discussed above with respect to FIG. 5.

The UE cooperation module 608 may perform functions described with reference to the other figures herein. The UE cooperation module 608 may transmit a cooperative UE update request to a BS 105 (or 500) indicating multiple candidate cooperative UE sets. The UE cooperation module 608 may receive from the BS 105 which of the candidate cooperative UE sets is preferred (taking advantage of the additional information available at the BS 500 and providing to the UE 600, such as via RRC reconfiguration messaging). The determination may be based on a number of criteria, which may include UE-side information transmitted by the UE 600 to the BS 105 and/or cooperative UEs 600 and may include BS-side information about the UEs 600 or other network information. UE-side information may be included in the cooperative UE update request and/or in a separate message from the UE 600. In some aspects, the UE cooperation module 608 receives requests for additional information from the BS 105, which may aid the BS 105 in making a determination of the preferred cooperative UE set. The UE cooperation module 608 may also be triggered to perform additional measurements by the BS 105.

UE-side information may be gathered by the UE cooperation module 608 as a part of or after discovery and connection with another UE 115. Information may be broadcast by the other UE 115, or may be a direct communication via a (non-cooperative) sidelink connection. Information may also be determined as a measurement of signals between the UE 600 and the other UE 115. Examples of UE-side information may include information about multiple candidate cooperative UE sets. UE sets may be indicated by UE IDs and/or panel IDs. UE-side information may also include UE capability information. UE capability information may include whether the UE or UE set is capable of single downlink control information (sDCI) or multiple downlink control information (mDCI) operation. UE capability information may also include whether the UE or UE set is capable of multiple transmission/reception point (multi-TRP) communication. Sidelink related information may also be included such as link latency between UEs in each candidate cooperative UE set. Other early measurements between UEs 115 (such as before cooperation) and information shared between UEs 115 may include UE measurements on a broadcasting channel, UE measurements on a dedicated (unicast) channel, UE position, preferred SSB indices, preferred beams/reference signals, UE physical cell ID (PCI), layer 1 (L1) reference signal received power (RSRP), and layer 3 (L3) RSRP, etc.

The UE cooperation module 608 may also be triggered to perform additional measurements and/or transmit additional signals for measurement by the BS 105 (to aid the BS 105 in making the determination). These measurements may include UL and DL measurements associated with the target UE 600 and/or the cooperative UEs 600. An example of a triggered UL measurement is a random access channel (RACH), or physical random access channel (PRACH) UL transmission. The UE cooperation module 608 may be triggered to perform a contention based PRACH transmission, and then the UE 600 may transmit a PRACH based on its measurement on the PRACH resource associated SSBs or CSI-RS. For example, the UE cooperation module 608 may choose to transmit a PRACH associated with a best measured SSB. In this way the BS 105 may determine the best SSB for the UE 600. A contention free random access UL may be triggered, but a contention based random access (CBRA) communication may be used with less configuration information.

An example of a triggered DL measurement is an explicit DCI configuration for channel state information (CSI) measurement on the UE 600. The UE 600 may receive RRC messaging from the BS 105 that reconfigures the UE 600 for CSI reports with respect to a cooperative UE 600, and subsequently receive a DCI message from the BS 105 that triggers the CSI request. The UE cooperation module 608 may then receive channel measurement resources (CMR) from the BS 105. Based on DL measurements of the CMR, each UE 600 may return a CSI report to the BS 105 indicating which beams are preferred by each UE 600. DL measurements by different UEs 600 may be communicated directly to the BS 500 by each UE 600, or may be communicated via the target UE 600 to the BS 105.

The BS 105 may use all or a subset of the information communicated by the UE 600 in addition to BS-side information in determining which cooperative UE set to configure for UE cooperation for the requesting (target) UE 115. The UE cooperation module 608 may receive an indication from the BS 105 of the selected UE set. For example this may be an indication of UE and/or panel IDs for the cooperative UE(s) 115, or an indication of which of the sets listed by the UE 600 is selected. The UE cooperation module 608 may also receive a configuration (e.g. an RRC configuration) from the BS 105 of the UE set selected for UE cooperation. The UE cooperation module 608 may then communicate with the network cooperatively with the configured cooperative UE or UEs 600.

As shown, the transceiver 610 may include the modem subsystem 612 and the RF unit 614. The transceiver 610 can be configured to communicate bi-directionally with other devices, such as the BSs 105. The modem subsystem 612 may be configured to modulate and/or encode the data from the memory 604 and/or the UE cooperation module 608 according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., UE capability report, beam reports, information sets, UE cooperation data, etc.) from the modem subsystem 612 (on outbound transmissions) or of transmissions originating from another source such as another UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together at the UE 600 to enable the UE 600 to communicate with other devices.

The RF unit 614 may provide the modulated and/or processed data, e.g. data packets (or, more generally, data messages that may include one or more data packets and other information), to the antennas 616 for transmission to one or more other devices. The antennas 616 may further receive data messages transmitted from other devices. The antennas 616 may provide the received data messages for processing and/or demodulation at the transceiver 610. The transceiver 610 may provide the demodulated and decoded data (e.g., candidate cooperative UE information sets) to the UE cooperation module 608 for processing. The antennas 616 may include multiple antennas of similar or different designs in order to sustain multiple transmission links. The RF unit 614 may configure the antennas 616. In some aspects, the antennas 616 may be in the form of one or more antenna panels or one or more antenna arrays each including a plurality of antenna elements that can be selectively configured with different gains and/or phases to generate a beam for transmission and/or reception.

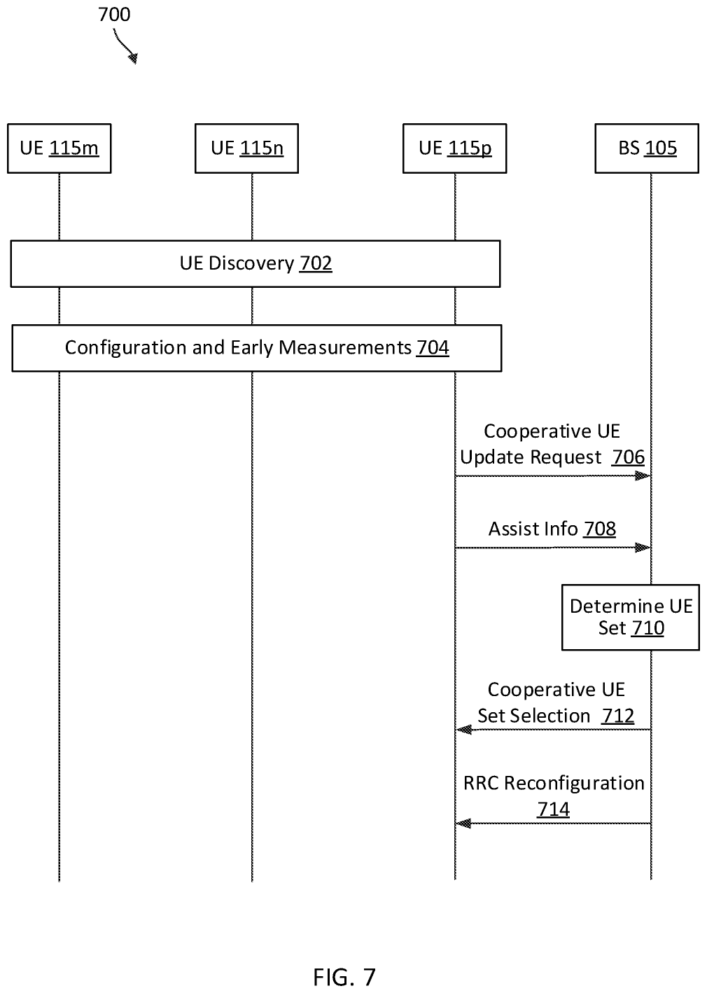

FIG. 7 is an exemplary communication protocol diagram 700, illustrating a method of BS assistance in UE cooperation. Aspects of the protocol diagram 700 may be performed by wireless networks, such as the networks 100, 200, 300, and/or 400. An additional BS 105 or UE 115 may perform the actions described in communication protocol diagram 700 when the network is in a configuration such as those illustrated in FIGS. 2, 3, and 4. Communication described as occurring with BS 105 may occur with a separate BS 105, and information may be shared between the BSs 105 via a backhaul connection (or may be conveyed from the separate BSs 105 to some other common network component). For simplicity of illustration and discussion, communication protocol diagram 700 is illustrated with a single BS 105 and three UEs 115 which may perform functions of the communication protocol diagram 700. In some instances, the BS 105 may utilize TRPs to communicate with the UEs 115.

In some aspects, the BS 105 may utilize one or more components, such as the processor 502, the memory 504, the UE cooperation assist module 508, the transceiver 510, the modem 512, and the one or more antennas 516 shown in FIG. 5, and the UE 115 may utilize one or more components, such as the processor 602, the memory 604, the UE cooperation module 608, the transceiver 610, the modem 612, and the one or more antennas 616 shown in FIG. 6. As illustrated, the protocol diagram 700 includes a number of enumerated actions, but aspects of FIG. 7 may include additional actions before, after, and in between the enumerated actions. In some aspects, one or more of the enumerated actions may be omitted, combined together, or performed in a different order.

At action 702, UE 115p discovers UE 115n and UE 115m. Discovery may be of any UEs 115 within range of the UE 115p. Alternatively, discovery may be limited to UEs 115 which meet some criteria, for example, a threshold sidelink pathloss or a UE capability criteria (as just two examples; other examples may include location, link status, or other availability information).

At action 704, UE 115p gathers early measurements and other information from UE 115n and UE 115m Early measurements may include UE measurements on a broadcasting channel, UE measurements on a dedicated channel, UE position, preferred SSB indices, preferred beams/reference signals, UE physical cell ID (PCI), layer 1 (L1) reference signal received power (RSRP), and layer 3 (L3) RSRP. Information may also include capability information about UE 115n and UE 115m in addition to other UE-side information. UE capability information may include whether the UE or UE set is capable of single downlink control information (sDCI) or multiple downlink control information (mDCI) operation. UE capability information may also include whether the UE or UE set is capable of multiple transmission/reception point (multi-TRP) communication. Sidelink related information may also be communicated to UE 115p such as link latency of each sidelink channel.

At action 706, UE 115p transmits a cooperative UE update request to BS 105. The cooperative UE update request indicates multiple candidate cooperative UE sets. UE sets may be indicated by UE IDs and/or panel IDs (e.g., by the UE 115p including UE IDs and/or panel IDs for each UE included in each candidate cooperative UE set). Each candidate cooperative UE set includes the target UE 115 (here UE 115p), and one or more additional UEs 115 (here UE 115m and/or 115n). Thus, where there are multiple candidate cooperative UEs with which the UE 115p may cooperate, UE 115p may generate different permutations of sets to send to the BS 105. Further, sometimes the same set of UEs may be indicated multiple times associated with different capabilities. For example, UE set “A” may include UE 115p and UE 115n with a capability for single DCI, and UE set “B” may also include UE 115p and UE 115n but with a capability for multi-DCI.

At action 708, UE 115p transmits assistance information to BS 105. The assistance information may include the UE capabilities and other information collected as part of action 702 and 704. For example, this may be sent as a multiple cooperate UE sets report that includes additional cooperative UE information such as one or more of UE measurements on a broadcasting channel, UE measurements on a unicast channel, UE position, preferred SSB indices, preferred beams/reference signals, UE physical cell ID (PCI), layer 1 (L1) reference signal received power (RSRP), and layer 3 (L3) RSRP. The UE-side information may be sent jointly with the capability information, or separately. When sent separately, the UE-side information may be sent in response to a separate request from BS 105. Capability information may also in some aspects be sent by UE 115p in response to an explicit request from BS 105 rather than together with the cooperative UE update request.

At action 710, BS 105 determines the preferred cooperative UE set for the target UE 115p. The determination may be based on multiple criteria such as the received UE capability information, UE-side information, and BS-side information. The information may be used together in various ways, for example different information may be weighted differently to arrive at a relative score which is used to determine the preferred UE set. For example, the amount of time a candidate cooperative UE is available based on its DRX configuration may be considered a more important factor than the inter-TRP link latency to the TRP with which that candidate cooperative UE is communicating. In some aspects, information is used in combination in other ways. For example, the BS 105 may consider the location of a UE 115 together with information about the status of a nearby TRP. As a simple example, if UE 115n was near a TRP which is currently turned off, then BS 105 may determine that turning on that TRP and using UE 115n for cooperation would be preferred (e.g., because it would optimize some target parameter such as signal strength, or throughput, etc.). As another example, information about preferred beams of the candidate cooperative UEs 115 may be used in combination with transmit beam separation information about those preferred beams at the BS 105. The BS 105 may prefer to select a set where the preferred beams have a greater transmit beam separation at the BS 105. In a further example, inter-TRP link information such as inter-TRP latency information may be used together with information about a preferred beam of a UE 115 which indicates a UE prefers communicating with a certain TRP. The BS 105 may prefer to select a set of UEs 115 for cooperation where the preferred communication paths have a lower latency.

At action 712, the selected cooperative UE set is indicated to UE 115p. This may be a separate action from, or a part of action 714. For example, the BS 105 may send to UE 115p an indication of UE and/or panel IDs for the cooperative UE(s) 115, or an indication of which of the sets listed by UE 115p is selected.

At action 714, BS 105 reconfigures UE 115p via RRC for UE cooperation with the selected cooperative UE set. The reconfiguration may include the configuration information by which to complete configuration of the cooperative UE set that was indicated as selected by the BS 105 at action 712. Once configuration is completed, UE 115p may communicate with BS 105 via cooperation with the indicated cooperative UE 115 as a single, virtual UE.

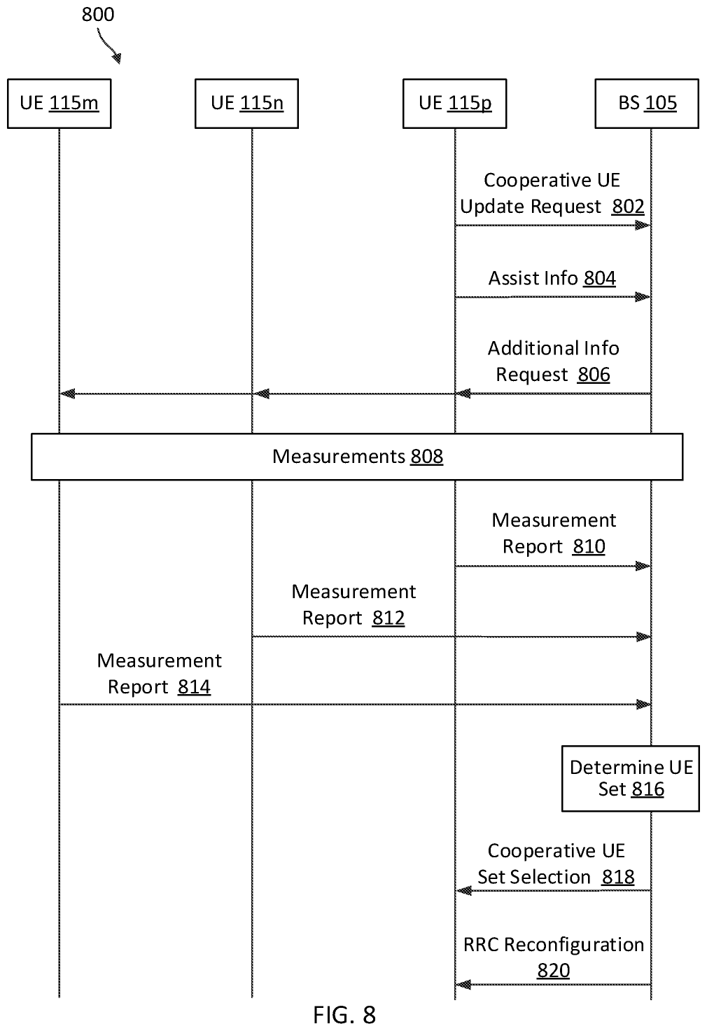

FIG. 8 is an exemplary communication protocol diagram 800, illustrating a method of BS assistance in UE cooperation. Aspects of the protocol diagram 800 may be performed by wireless networks, such as the networks 100, 200, 300, and/or 400. An additional BS 105 or UE 115 may perform the actions described in communication protocol diagram 800 when the network is in a configuration such as those illustrated in FIGS. 2, 3, and 4. Communication described as occurring with BS 105 may occur with a separate BS 105, and information may be shared between the BSs 105 via a backhaul connection (or may be conveyed from the separate BSs 105 to some other common network component). For simplicity of illustration and discussion, communication protocol diagram 800 is illustrated with a single BS 105 and three UEs 115 which may perform functions of the communication protocol diagram 800. In some instances, the BS 105 may utilize TRPs to communicate with the UEs 115.

In some aspects, the BS 105 may utilize one or more components, such as the processor 502, the memory 504, the UE cooperation assist module 508, the transceiver 510, the modem 512, and the one or more antennas 516 shown in FIG. 5, and the UE 115 may utilize one or more components, such as the processor 602, the memory 604, the UE cooperation module 608, the transceiver 610, the modem 612, and the one or more antennas 616 shown in FIG. 6. As illustrated, the protocol diagram 800 includes a number of enumerated actions, but aspects of the FIG. 8 may include additional actions before, after, and in between the enumerated actions. In some aspects, one or more of the enumerated actions may be omitted, combined together, or performed in a different order.

At action 802, UE 115p transmits a cooperative UE update request to BS 105. The cooperative UE update request indicates multiple candidate cooperative UE sets. UE sets may be indicated by UE IDs and/or panel IDs (e.g., by the UE 115p including UE IDs and/or panel IDs for each UE included in each candidate cooperative UE set). Each candidate cooperative UE set includes the target UE 115 (here UE 115p), and one or more additional UEs 115 (here UE 115m and/or 115n). Thus, where there are multiple candidate cooperative UEs with which the UE 115p may cooperate, UE 115p may generate different permutations of sets to send to the BS 105. Further, sometimes the same set of UEs may be indicated multiple times associated with different capabilities. For example, a first UE set may include UE 115p and UE 115n with a capability for single DCI, and a second UE set may also include UE 115p and UE 115n but with a capability for multi-DCI.

At action 804, UE 115p transmits assistance information to BS 105. The assistance information may include capability information regarding the UEs and/or candidate cooperative UE sets. The assistance information may include other UE-side information. The UE-side information may be sent jointly with the capability information, or separately. When sent separately, the UE-side information may be sent in response to a separate request from BS 105 either before or after the capability information. UE-side information may include, among other things, UE measurements on a broadcasting channel, UE measurements on a dedicated (unicast) channel, UE position, preferred SSB indices, preferred beams/reference signals, UE physical cell ID (PCI), layer 1 (L1) reference signal received power (RSRP), and layer 3 (L3) RSRP.

At action 806, BS 105 requests additional information from UE 115m, UE 115n, and UE 115p. The request may be sent in response to receiving the cooperative UE update request, or after the BS 105 determines that the received information is insufficient in order to optimally select a cooperative UE set. The message requesting additional information may be sent to the individual UEs 115, either directly to each UE 115 or via broadcast. Alternatively, the BS 105 may send the message requesting additional information to UE 115p, which in turn may convey the request to the other UEs 115m and UE 115n.

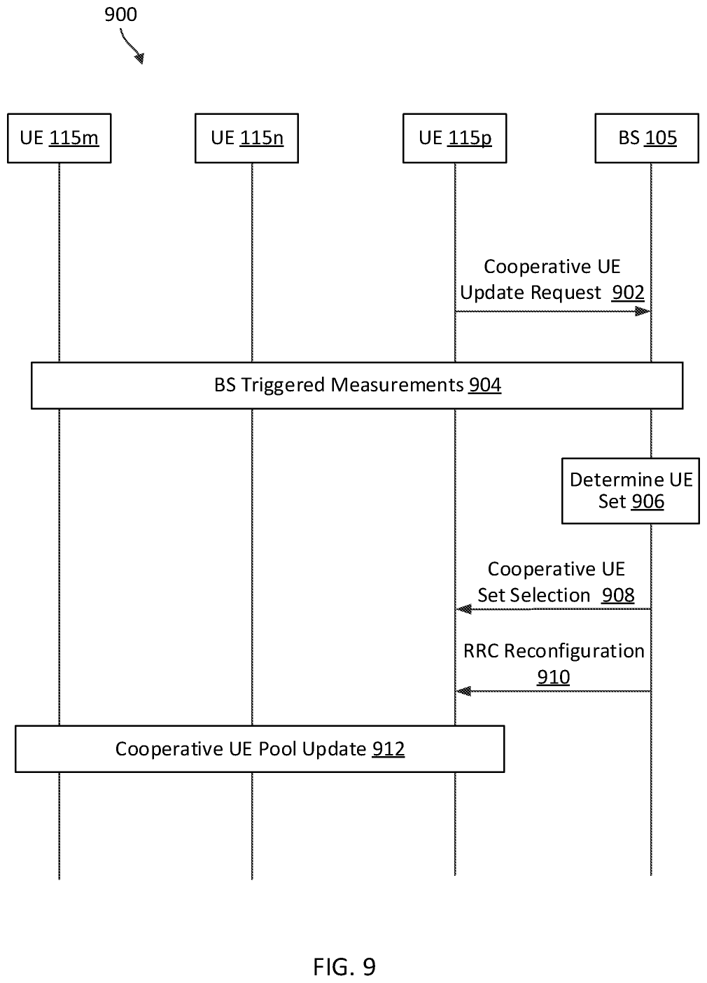

At action 808, the UEs 115 perform additional measurements in response to the request from BS 105 received at action 806. These measurements may include DL measurements of signals from BS 105, or may include signals transmitted by the UEs 115 to the BS 105 such that BS 105 may perform measurements. Aspects discussed with respect to FIGS. 9-11 below include exemplary additional measurements which may be performed.

At action 810, UE 115p transmits a measurement report to BS 105 in response to the additional measurements performed at action 808. The measurement report may include indirect reports from UE 115m and UE 115n. That is, the UE 115p may include in its measurement report at action 810 measurement reports by UEs 115m and 115n received via sidelink. Alternatively, at actions 812 and 814, UEs 115m and 115n may transmit measurement reports to BS 105 without relying upon UE 115p.

At action 816, BS 105 determines the preferred cooperative UE set for target UE 115p. The determination may be based on multiple criteria such as the received UE capability information, UE-side information, additional measurements, and BS-side information. BS-side information may include environment information such as stationary UEs 115 available for UE cooperation, DRX configurations of various UEs 115, and sensing results from higher layers. For example, the BS 105 may perform sensing of UE position using mm Wave signal as radar. BS-side information may also include UE 115 TX beam information such as transmit beam separation at the BS 105. BS-side information may also include information about other BSs 105 or other TRPs. For example, such information may include TRP on/off status, and inter-TRP link condition (e.g. latency).

The information may be used together in various ways in order to determine the preferred cooperative UE set. In some aspects, different information may be weighted differently to arrive at a relative score which is used to determine the preferred UE set. For example, the amount of time a candidate cooperative UE is available based on its DRX configuration may be considered a more important factor than the inter-TRP link latency to the TRP with which that candidate cooperative UE is communicating. In some aspects, information is used in combination in other ways. For example, the BS 105 may consider the location of a UE 115 together with information about the status of a nearby TRP. As one simple example, if UE 115n was near a TRP which is currently turned off, then BS 105 may determine that turning on that TRP and using UE 115n for cooperation with UE 115p would be preferred (e.g,, because it would optimize some target parameter such as signal strength, or throughput, etc.). In another example, the BS 105 may use TRP on/off status and UE location information independently. The location of a UE 115 may be used in order to prefer a UE 115 for cooperation that is closer to the BS 105. The TRP on/off status may be used to prefer a UE which is communicating via a TRP that is currently on.

At action 818, the selected cooperative UE set is indicated to UE 115p. This may be a separate action from, or a part of action 820. For example, the BS 105 may send to UE 115p an indication of UE and/or panel IDs for the cooperative UE(s) 115, or an indication of which of the sets listed by UE 115p is selected

At action 820, BS 105 reconfigures UE 115p via RRC for UE cooperation with the selected cooperative UE set. The reconfiguration may include the configuration information by which to complete configuration of the cooperative UE set that was indicated as selected by the BS 105 at action 818. Once configuration is completed, UE 115p may communicate with BS 105 via cooperation with the indicated cooperative UE 115 as a single, virtual UE.

FIG. 9 is an exemplary communication protocol diagram 900, illustrating a method of BS assistance in UE cooperation. Aspects of the protocol diagram 900 may be performed by wireless networks, such as the networks 100, 200, 300, and/or 400. An additional BS 105 or UE 115 may perform the actions described in communication protocol diagram 900 when the network is in a configuration such as those illustrated in FIGS. 2, 3, and 4. Communication described as occurring with BS 105 may occur with a separate BS 105, and information may be shared between the BSs 105 via a backhaul connection (or may be conveyed from the separate BSs 105 to some other common network component). For simplicity of illustration and discussion, communication protocol diagram 900 is illustrated with a single BS 105 and three UEs 115 which may perform functions of the communication protocol diagram 900. In some instances, the BS 105 may utilize TRPs to communicate with the UEs 115.

In some aspects, the BS 105 may utilize one or more components, such as the processor 502, the memory 504, the UE cooperation assist module 508, the transceiver 510, the modem 512, and the one or more antennas 516 shown in FIG. 5, and the UE 115 may utilize one or more components, such as the processor 602, the memory 604, the UE cooperation module 608, the transceiver 610, the modem 612, and the one or more antennas 616 shown in FIG. 6. As illustrated, the protocol diagram 900 includes a number of enumerated actions, but aspects of the FIG. 9 may include additional actions before, after, and in between the enumerated actions. In some aspects, one or more of the enumerated actions may be omitted, combined together, or performed in a different order.

At action 902, UE 115p transmits a cooperative UE update request to BS 105. The cooperative UE update request indicates multiple candidate cooperative UE sets. UE sets may be indicated by UE IDs and/or panel IDs (e.g., by the UE 115p including UE IDs and/or panel IDs for each UE included in each candidate cooperative UE set). Each candidate cooperative UE set includes the target UE 115 (here UE 115p), and one or more additional UEs 115 (here UE 115m and/or 115n). Thus, where there are multiple candidate cooperative UEs with which the UE 115p may cooperate, UE 115p may generate different permutations of sets to send to the BS 105. Further, sometimes the same set of UEs may be indicated multiple times associated with different capabilities. For example, a first UE set may include UE 115p and UE 115n with a capability for single DCI, and a second UE set may also include UE 115p and UE 115n but with a capability for multi-DCI.

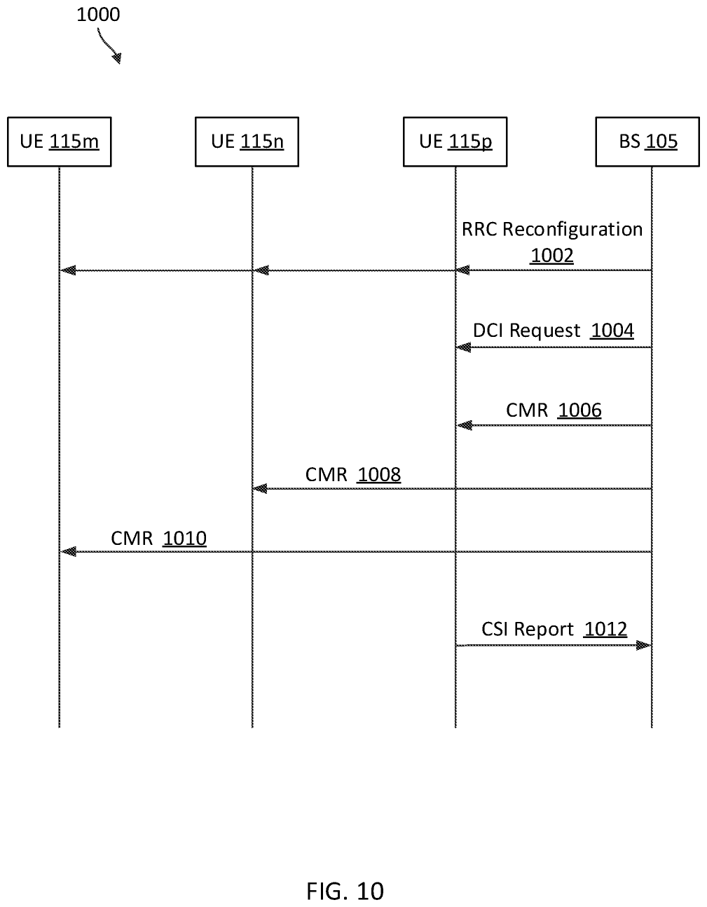

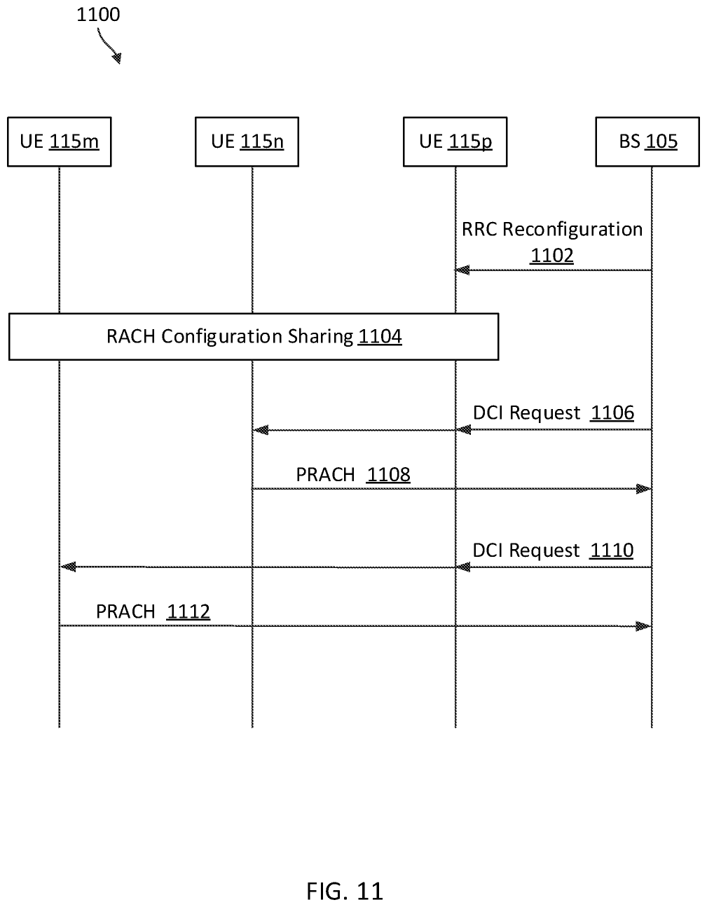

At action 904, BS 105 requests and triggers additional measurements among the UEs 115. The message requesting additional information may be sent to the individual UEs 115, or may be only sent to UE 115p, which may indirectly report back the additional information. These measurements may include DL measurements of signals from BS 105, or may include signals transmitted by the UEs 115 to the BS 105 such that BS 105 may perform measurements. FIGS. 10-11 illustrate examples of such additional measurements and methods by which they may be performed and reported.

At action 906, BS 105 determines the preferred cooperative UE set. The determination may be based on multiple criteria such as the triggered UL and DL measurements, and BS-side information. As discussed with respect to FIG. 8, in some aspects other UE-side information including UE capabilities may be considered by the BS 105 in determining the preferred UE set. The information may be used together in various ways, for example different information may be weighted differently to arrive at a relative score which is used to determine the preferred UE set. In some aspects, information is used in combination in other ways. For example, information about preferred beams of the candidate cooperative UEs 115 may be used in combination with transmit beam separation information about those preferred beams at the BS 105. The BS 105 may prefer to select a set where the preferred beams have a greater transmit beam separation at the BS 105. In a further example, inter-TRP link information such as inter-TRP latency information may be used together with information about a preferred beam of a UE 115 which indicates a UE prefers communicating with a certain TRP. The BS 105 may prefer to select a set of UEs 115 for cooperation where the preferred communication paths have a lower latency.

At action 908, the selected cooperative UE set is indicated to UE 115p. This may be a separate action from, or a part of action 820. For example, the BS 105 may send to UE 115p an indication of UE and/or panel IDs for the cooperative UE(s) 115, or an indication of which of the sets listed by UE 115p is selected.

At action 910, BS 105 reconfigures UE 115p via RRC for UE cooperation with the selected cooperative UE set. The reconfiguration may include the configuration information by which to complete configuration of the cooperative UE set that was indicated as selected by the BS 105 at action 908. Once configuration is completed, UE 115p may communicate with BS 105 via cooperation with the indicated cooperative UE 115 as a single, virtual UE.

At action 912, the cooperative UE pool is updated. As UE 115p has at this point determined, based on assistance from BS 105, which UE 115 or UEs 115 with which to cooperate, other UEs may be released from the UE pool. While this action is described with respect to FIG. 9, it may be performed as part of the methods described with reference to other figures herein.

FIG. 10 is an exemplary communication protocol diagram 1000, illustrating a method of BS assistance in UE cooperation. Specifically, protocol diagram 1000 is an example of a protocol for performing BS triggered measurements such as is discussed in general with respect to action 808 of FIG. 8 and action 904 of FIG. 9. As such, aspects of protocol diagram 1000 may be performed by components as discussed with respect to FIG. 9. As illustrated, the protocol diagram 1000 includes a number of enumerated actions, but aspects of the FIG. 10 may include additional actions before, after, and in between the enumerated actions. In some aspects, one or more of the enumerated actions may be omitted, combined together, or performed in a different order.

At action 1002, BS 105 configures measurement reports on UEs 115p, 115n, and 115m via an RRC configuration. The RRC configuration may be performed directly with each UE 115, or may be done indirectly via the target UE 115p.

At action 1004, the BS 105 transmits a DCI request to UE 115p, which triggers the measurement and reporting.

At action 1006, a channel measurement resource (CMR) is communicated from BS 105 to UE 115p. For example, the CMR may be a resource indicated in the DCI request, or in a separate communication such as a CSI-RS. Likewise, at actions 1008 and 1010, respective CMRs are communicated by BS 105 to UE 115n and UE 115m.

At action 1012, UE 115p communicates a CSI report to BS 105. The CSI report may include the results of CSI measurements performed as configured by BS 105. The report may also contain the preferred beams for each UE 115. For example, UE 115n may be configured to receive a CSI-RS from multiple TRPs. In the CSI report from UE 115p, there may be an indication of which beam from which TRP is preferred by UE 115n. The CSI report is illustrated as coming only from UE 115p, which indicates that UE 115p receives CSI reports from UEs 115n and 115m. In some aspects, UEs 115n and 115m report directly to BS 105.

With this information, the BS 105 may then proceed with determining a cooperative UE set for the requesting UE 115p according to actions described with respect to various figures above, such as FIGS. 8 and 9.

FIG. 11 is an exemplary communication protocol diagram 1100, illustrating a method of BS assistance in UE cooperation. Specifically, protocol diagram 1100 is an example of a protocol for performing BS triggered measurements such as is discussed in general with respect to FIG. 8 and action 904 of FIG. 9. As such, aspects of protocol diagram 1000 may be performed by components as discussed with respect to FIG. 9. As illustrated, the protocol diagram 1100 includes a number of enumerated actions, but aspects of the FIG. 11 may include additional actions before, after, and in between the enumerated actions. In some aspects, one or more of the enumerated actions may be omitted, combined together, or performed in a different order. In the example of FIG. 11, measurements are triggered with respect to the RACH procedure, instead of CSI measurement reporting as was discussed above with respect to FIG. 10.

At action 1102, BS 105 configures UEs 115p, 115n, and 115m via an RRC configuration. The RRC configuration may be performed directly with each UE 115, or may be done indirectly via the target UE 115p. This may be an RRC reconfiguration message, specifically reconfiguring the RACH configuration with respect to the candidate cooperative UEs. This may be sent to the requesting UE 115p, and shared with the candidate cooperative UEs 115m and 115n at action 1104.

At action 1104, The UE 115p shares the RACH reconfiguration information received at action 1102.

At action 1106, BS 105 triggers a contention based PRACH transmission by sending a DCI to UE 115p and in turn UE 115n. For example, the BS 105 may transmit the DCI to UE 115p with information identifying the DCI as intended for UE 115n (e.g, by including an identifier of UE 115n as well as other information, such as what SSB index and identification of contention-based random access (CBRA)). Alternatively, the BS 105 may trigger a contention-free based PRACH transmission via the DCI. The UE 115p may, upon receipt of this and locating the identifier of UE 115n in the DCI, convey the DCI to UE 115n.

At action 1108, UE 115n transmits a PRACH based on its measurement on the PRACH resource associated SSBs or CSI-RS. For example, UE 115n may transmit a PRACH associated with a best measured SSB (whether the same SSB as identified in the DCI at action 1106 or different to it). Alternatively, the UE 115n transmits the PRACH based on a SSB measurement (e.g., RSRP) that is above a predetermined or configured threshold. Thereby BS 105 may identify the preferred SSB of UE 115n.

At action 1110, BS 105 triggers a contention based PRACH transmission by sending a DCI to UE 115p and in turn UE 115m. Similar to as discussed with respect to action 1106, the BS 105 may transmit the DCI to UE 115p with information identifying the DCI as intended for UE 115m (e.g., by including an identifier of UE 115m as well as other information, such as what SSB index and identification of contention-based random access (CBRA)). Alternatively, the BS 105 may trigger a contention-free based PRACH transmission via the DCI. The UE 115p may, upon receipt of this and locating the identifier of UE 115m in the DCI, convey the DCI to UE 115m. This may occur at a different time than action 1106, or overlapping in time to action 1106.

At action 1112, UE 115m transmits a PRACH based on its measurement on the PRACH resource associated SSBs or CSI-RS. For example, UE 115m may transmit a PRACH associated with a best measured SSB. Thereby BS 105 may identify the preferred SSB of UE 115m. This may occur at a different time than action 1108 or overlapping in time to action 1108.

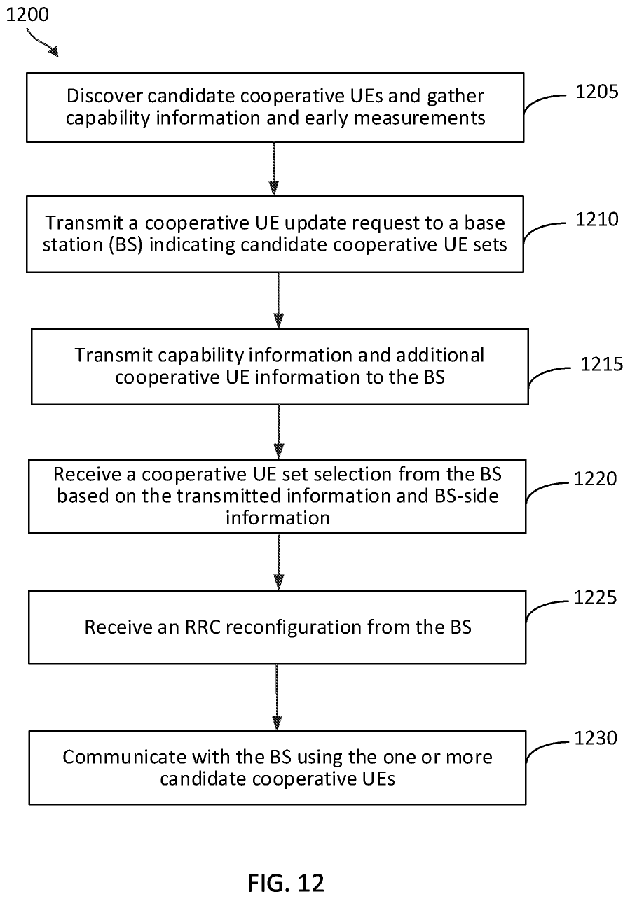

FIG. 12 is an exemplary flow diagram, illustrating a method 1200 of BS assistance in UE cooperation. Aspects of the method 1200 can be executed by a computing device (e.g., a processor, processing circuit, and/or other suitable component) of a wireless communication device or other suitable means for performing the steps. For example, a UE (e.g., UE 115 of FIG. 1) may utilize one or more components, such as the processor 602, the memory 604, the UE cooperation module 608, the transceiver 610, the modem 612, and the one or more antennas 616 shown in FIG. 6. As illustrated, the method 1200 includes a number of enumerated steps, but aspects of the method 1200 may include additional steps before, after, and in between the enumerated steps. In some aspects, one or more of the enumerated steps may be omitted or performed in a different order.

At block 1205, a target UE 115 discovers candidate cooperative UEs 115 and gathers capability information and early measurements from the candidate cooperative UEs 115. Discovery may be limited to UEs 115 which meet some criteria, for example, a threshold sidelink pathloss or a UE capability criteria. Gathered information may include capability information about UE 115n and UE 115m in addition to other UE-side information. UE capability information may include whether the candidate cooperative UE 115 or UE set is capable of single downlink control information (sDCI) or multiple downlink control information (mDCI) operation. UE capability information may also include whether the UE or UE set is capable of multiple transmission/reception point (multi-TRP) communication. Sidelink related information may also be communicated to UE 115p such as link latency of each sidelink channel. Other early measurements may include UE measurements on a broadcasting channel, UE measurements on a unicast channel, UE position, preferred SSB indices, preferred beams/reference signals, UE physical cell ID (PCI), layer 1 (L1) reference signal received power (RSRP), and layer 3 (L3) RSRP.

At block 1210, the target UE 115 transmits a cooperative UE update request to a BS 105 indicating candidate cooperative UE sets. The cooperative UE update request indicates multiple candidate cooperative UE sets. UE sets may be indicated by UE IDs and/or panel IDs. Each candidate cooperative UE set includes the target UE 115, and one or more additional UEs 115. Thus, where there are multiple candidate cooperative UEs with which the UE 115p may cooperate, the target UE 115 may generate different permutations of sets to send to the BS 105. Further, sometimes the same set of UEs may be indicated multiple times associated with different capabilities. For example, a first UE set may include the target UE and a candidate cooperative UE “X” with a capability for single DCI, and a second UE set may also include the target UE 115 and the candidate cooperative UE “X” but with a capability for multi-DCI.

At block 1215, the target UE 115 transmits the capability information and additional cooperative UE information to the BS 105.

At block 1220, the target UE 115 receives a cooperative UE set selection from the BS 105 based on the transmitted information and BS-side information. BS-side information may include environment information such as stationary UEs 115 available for UE cooperation, DRX configurations of various UEs 115, and sensing results from higher layers. For example, the BS 105 may perform sensing of UE position using mmWave signal as radar. BS-side information may also include UE 115 TX beam information such as transmit beam separation at the BS 105. BS-side information may also include information about other BSs 105 or other TRPs. For example, TRP on/off status, and inter-TRP link condition (e.g. latency).

At block 1225, the target UE 115 receives an RRC reconfiguration from the BS, configuring UE cooperation using the determined cooperative UE set. The reconfiguration may include the configuration information by which to complete configuration of the cooperative UE set that was indicated as selected by the BS 105 at block 1220. Once configuration is completed, target UE 115 may communicate with BS 105 via cooperation with the indicated cooperative UE 115 as a single, virtual UE.

At block 1230, the target UE 115 communicates with the BS using the one or more candidate cooperative UEs configured for cooperation.

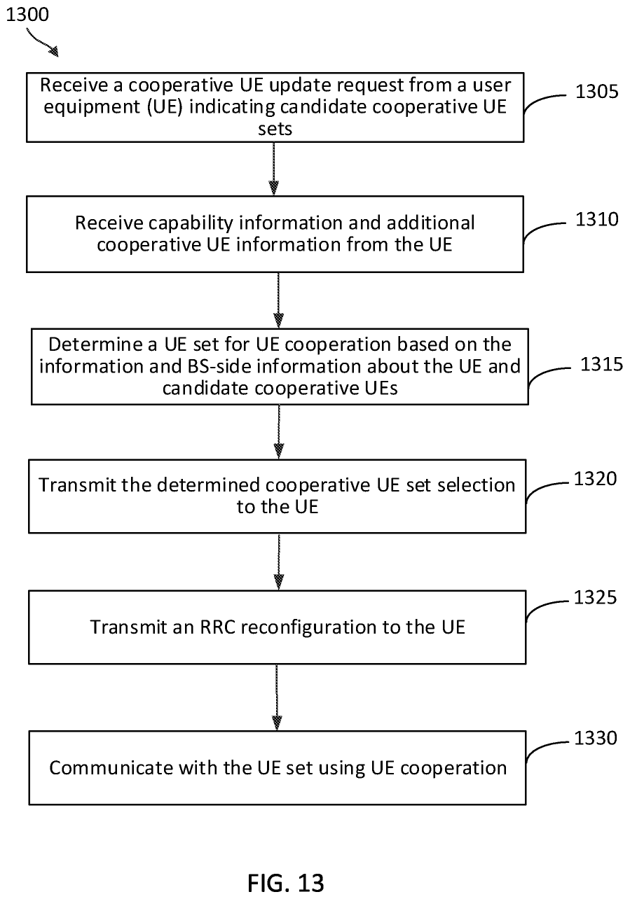

FIG. 13 is an exemplary flow diagram 1300, illustrating a method of BS assistance in UE cooperation. Aspects of the method 1300 can be executed by a computing device (e.g., a processor, processing circuit, and/or other suitable component) of a wireless communication device or other suitable means for performing the steps. For example, a BS 105 may utilize one or more components, such as the processor 502, the memory 504, the UE cooperation assist module 508, the transceiver 510, the modem 512, and the one or more antennas 516 shown in FIG. 5. As illustrated, the method 1300 includes a number of enumerated steps, but aspects of the method 1300 may include additional steps before, after, and in between the enumerated steps. In some aspects, one or more of the enumerated steps may be omitted or performed in a different order.

At block 1305, a BS 105 receives a cooperative UE update request from a UE 115 indicating candidate cooperative UE sets. The cooperative UE update request indicates multiple candidate cooperative UE sets. UE sets may be indicated by UE IDs and/or panel IDs. Each candidate cooperative UE set includes the target UE 115, and one or more additional UEs 115. Thus, where there are multiple candidate cooperative UEs with which the UE 115p may cooperate, the target UE 115 may generate different permutations of sets to send to the BS 105. Further, sometimes the same set of UEs may be indicated multiple times associated with different capabilities. For example, a first UE set may include the target UE and a candidate cooperative UE “X” with a capability for single DCI, and a second UE set may also include the target UE 115 and the candidate cooperative UE “X” but with a capability for multi-DCI.

At block 1310, the BS 105 receives capability information and additional cooperative UE information from the UE 115. The received information may include capability information about the target UE 115 and any candidate cooperative UE 115 in addition to other UE-side information. UE capability information may include whether the candidate cooperative UE 115 or UE set is capable of single downlink control information (sDCI) or multiple downlink control information (mDCI) operation. UE capability information may also include whether the UE or UE set is capable of multiple transmission/reception point (multi-TRP) communication. Sidelink related information may also be communicated to UE 115p such as link latency of each sidelink channel. Other early measurements may include UE measurements on a broadcasting channel, UE measurements on a unicast channel, UE position, preferred SSB indices, preferred beams/reference signals, UE physical cell ID (PCI), layer 1 (L1) reference signal received power (RSRP), and layer 3 (L3) RSRP.

At block 1315, the BS 105 determines a UE set for UE cooperation based on the information and BS-side information about the UE 115 and candidate cooperative UEs 115. BS-side information may include environment information such as stationary UEs 115 available for UE cooperation, DRX configurations of various UEs 115, and sensing results from higher layers. For example, the BS 105 may perform sensing of UE position using mm Wave signal as radar. BS-side information may also include UE 115 TX beam information such as transmit beam separation at the BS 105. BS-side information may also include information about other BSs 105 or other TRPs. For example, TRP on/off status, and inter-TRP link condition (e.g. latency).

The information may be used together in various ways, for example different information may be weighted differently to arrive at a relative score which is used to determine the preferred UE set. For example, the amount of time a candidate cooperative UE is available based on its DRX configuration may be considered a more important factor than the inter-TRP link latency to the TRP with which that candidate cooperative UE is communicating. In some aspects, information is used in combination in other ways. For example, the location of a UE 115 may be considered together with information about the status of a nearby TRP. If UE 115n was near a TRP which is currently turned off, then BS 105 may determine that turning on that TRP and using UE 115n for cooperation is preferred. As another example, information about preferred beams of the candidate cooperative UEs 115 may be used in combination with transmit beam separation information about those preferred beams at the BS 105. The BS 105 may prefer to select a set where the preferred beams have a greater transmit beam separation at the BS 105. In a further example, inter-TRP link information such as inter-TRP latency information may be used together with information about a preferred beam of a UE 115 which indicates a UE prefers communicating with a certain TRP. The BS 105 may prefer to select a set of UEs 115 for cooperation where the preferred communication paths have a lower latency.

At block 1320, the BS 105 transmits the determined cooperative UE set selection to the UE 115.

At block 1325, the BS 105 transmits an RRC reconfiguration to the UE according to the cooperative UE set selection. In some aspects, blocks 1320 and 1325 are performed as a single step.

At block 1330, the BS 105 communicates with the configured cooperative UE set using UE cooperation.

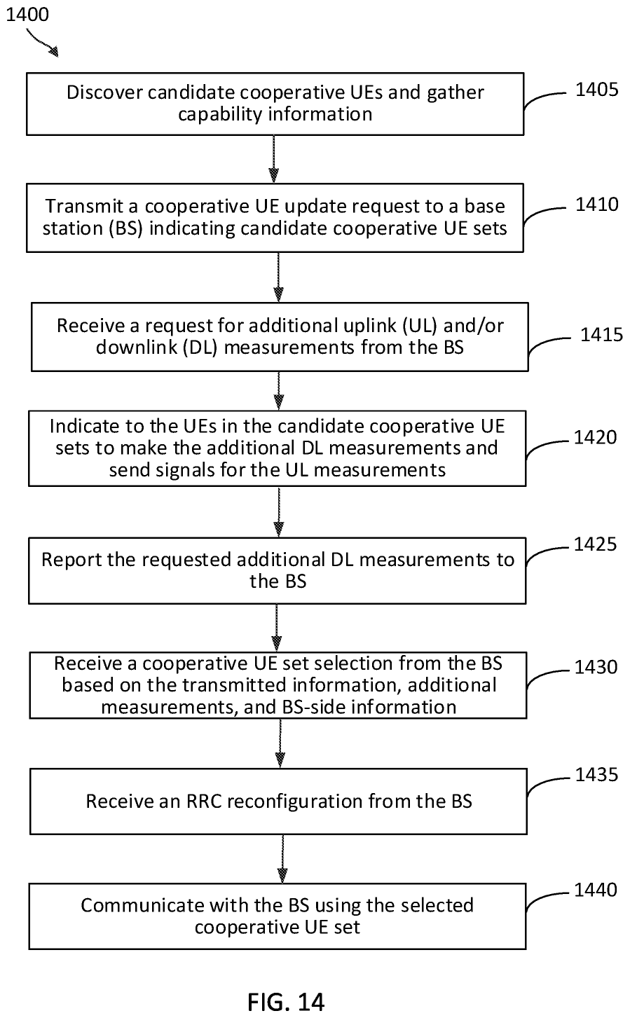

FIG. 14 is an exemplary flow diagram 1400, illustrating a method of BS assistance in UE cooperation. Aspects of the method 1400 can be executed by a computing device (e.g., a processor, processing circuit, and/or other suitable component) of a wireless communication device or other suitable means for performing the steps. For example, a UE (e.g., UE 115 of FIG. 1) may utilize one or more components, such as the processor 602, the memory 604, the UE cooperation module 608, the transceiver 610, the modem 612, and the one or more antennas 616 shown in FIG. 6. As illustrated, the method 1400 includes a number of enumerated steps, but aspects of the method 1400 may include additional steps before, after, and in between the enumerated steps. In some aspects, one or more of the enumerated steps may be omitted or performed in a different order.

At block 1405, a target UE 115 discovers candidate cooperative UEs 115 and gathers capability information regarding the candidate cooperative UEs 115. This is similar to block 1205 discussed with reference to FIG. 12.

At block 1410, the target UE 115 transmits a cooperative UE update request to a BS 105 indicating candidate cooperative UE sets. This is similar to block 1210 discussed with reference to FIG. 12.

At block 1415, the target UE 115 receives a request for additional UL and/or DL measurements from the BS 105. The message requesting additional information may be sent to the individual UEs 115, or may be only sent to the target UE 115, which may indirectly report back the additional information.

At block 1420, the target UE 115 indicates to the UEs 115 in the candidate cooperative UE sets to make the additional DL measurements and/or send signals for the UL measurements. These measurements may include DL measurements of signals from BS 105, or may include signals transmitted by the UEs 115 to the BS 105 on which BS 105 may perform measurements. Aspects discussed with respect to FIGS. 9-11 above include exemplary additional measurements which may be performed (e.g., using CMR or PRACH as two examples).

At block 1425, the target UE 115 reports the requested additional DL measurements to the BS 105. In some aspects, measurement reports are performed directly by each of the candidate cooperative UEs 115 (e.g., where CMR used as in FIG. 10 above; where PRACH is used, block 1425 may involve the transmission of PRACH which the BS 105 then uses to make measurements).

At block 1430, the target UE 115 receives a cooperative UE set selection from the BS 105 based on the transmitted information and additional measurements, as well as BS-side information.

At block 1435, the target UE 115 receives an RRC reconfiguration from the BS 105 setting up UE cooperation with the determined cooperative UE set.

At block 1440, the target UE 115 communicates with the BS 105 using the selected cooperative UE set.

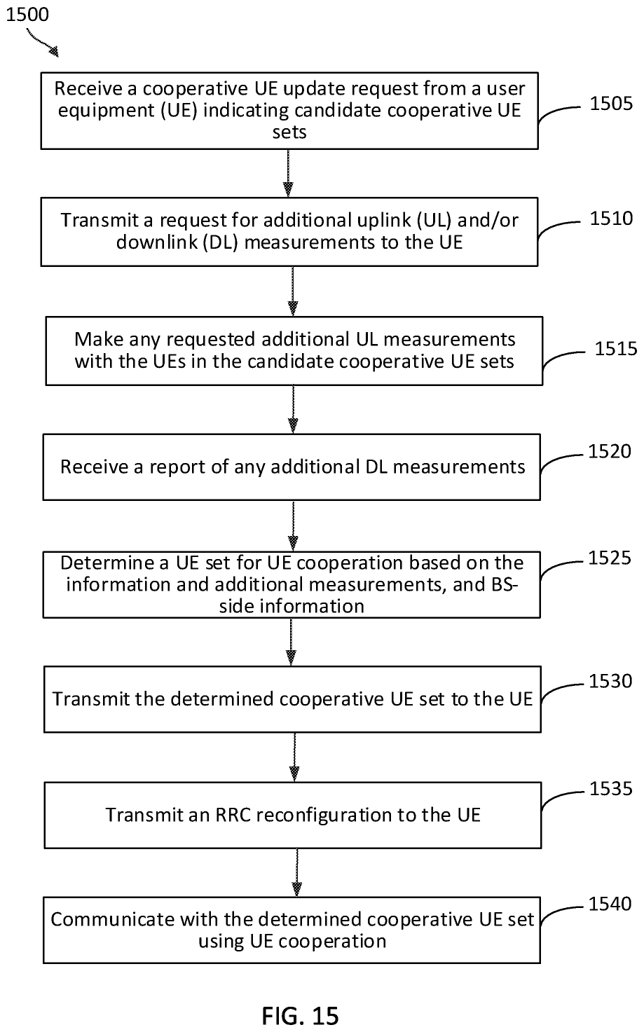

FIG. 15 is an exemplary flow diagram 1500, illustrating a method of BS assistance in UE cooperation. Aspects of the method 1500 can be executed by a computing device (e.g., a processor, processing circuit, and/or other suitable component) of a wireless communication device or other suitable means for performing the steps. For example, a BS 105 may utilize one or more components, such as the processor 502, the memory 504, the UE cooperation assist module 508, the transceiver 510, the modem 512, and the one or more antennas 516 shown in FIG. 5. As illustrated, the method 1500 includes a number of enumerated steps, but aspects of the method 1500 may include additional steps before, after, and in between the enumerated steps. In some aspects, one or more of the enumerated steps may be omitted or performed in a different order.

At block 1505, a BS 105 receives a cooperative UE update request from a target UE 115 indicating multiple candidate cooperative UE sets. This is similar to block 1305 discussed with respect to FIG. 13.

At block 1510, the BS 105 transmits a request for additional UL and/or DL measurements to the target UE 115. The request may be sent in response to receiving the cooperative UE update request, or after the BS 105 determines that the received information is insufficient in order to optimally select a cooperative UE set. The message requesting additional information may be sent to the individual UEs 115, or may be only sent to the target UE 115, which may indirectly report back the additional information. Examples of UL and DL measurements are discussed with respect to FIGS. 10 and 11.

At block 1515, the BS 105 makes any requested additional UL measurements with the UEs 115 in the candidate cooperative UE sets. If at action 1510 the BS 105 only requested DL measurements, then UL measurements may not be performed.

At block 1520, the BS 105 receives a report of any additional DL measurements. In some aspects, the report for each of the candidate cooperative UEs 115 is indirectly reported via the target UE 115. In other aspects, each UE 115 reports directly to the BS 105. If at action 1510 the BS 105 only requested UL measurements, then DL measurements may not be performed or reported.

At block 1525, the BS 105 determines a UE set for UE cooperation based on the information and additional measurements, as well as BS-side information. BS-side information may include environment information such as stationary UEs 115 available for UE cooperation, DRX configurations of various UEs 115, and sensing results from higher layers. For example, the BS 105 may perform sensing of UE position using mm Wave signal as radar. BS-side information may also include UE 115 TX beam information such as transmit beam separation at the BS 105. BS-side information may also include information about other BSs 105 or other TRPs. For example, TRP on/off status, and inter-TRP link condition (e.g. latency).

The information may be used together in various ways, for example different information may be weighted differently to arrive at a relative score which is used to determine the preferred UE set. In some aspects, information is used in combination in other ways. For example, the preferred beams of each UE 115 may be used together with BS-side information about the separation of those beams at the BS 105. The BS 105 may prefer cooperative UEs 115 with more transmit beam separation on their preferred beams.

At block 1530, the BS 105 transmits the determined cooperative UE set to the target UE 115.

At block 1535, the BS 105 transmits an RRC reconfiguration message to the target UE 115. In some aspects, blocks 1530 and 1535 may be performed together.

At block 1540, the BS 105 communicates with the determined cooperative UE set using UE cooperation.

The present disclosure also includes the following aspects:

Aspect 1. A method of wireless communication comprising:
transmitting, by a user equipment (UE) to a base station (BS), a cooperative UE update request comprising a plurality of candidate cooperative UE sets and a UE capability set associated with the plurality of candidate cooperative UE sets;
receiving, by the UE from the BS, an indication of a cooperative UE set comprising at least one of the plurality of candidate cooperative UE sets;
connecting, by the UE via a sidelink channel, to at least one cooperative UE associated with the cooperative UE set; and
communicating, by the UE with the BS, using the cooperative UE set.
   Aspect 2. The method of aspect 1, wherein the cooperative UE update request further comprises an information set associated with a plurality of candidate cooperative UEs in the plurality of candidate cooperative UE sets.
   Aspect 3. The method of aspect 2, wherein the information set comprises at least one of:
a sidelink channel information of the plurality of candidate cooperative UEs, a UE location information of the plurality of candidate cooperative UEs, or a channel measurement information of the plurality of candidate cooperative UEs.
   Aspect 4. The method of any of aspects 1-3, wherein the UE capability set comprises at least one of:
a multiple transmission/reception point (multi-TRP) capability, or
a multiple downlink control information (multi-DCI) capability.
   Aspect 5. The method of any of aspects 3-4, wherein the channel measurement information comprises at least one of:
a downlink (DL) measurement of a broadcast channel, or
a downlink (DL) measurement of a unicast UE channel.
   Aspect 6. The method of any of aspects 3-5, wherein the sidelink channel information comprises a link latency.
   Aspect 7. The method of any of aspects 3-6, wherein the information set further comprises at least one of:
a preferred synchronization signal block (SSB) index of the plurality of candidate cooperative UEs,
a physical cell ID (PCI) of the plurality of candidate cooperative UEs,
a layer 1 (L1) reference signal received power (RSRP) of the plurality of candidate cooperative UEs, or
a layer 3 (L3) RSRP of the plurality of candidate cooperative UEs.
   Aspect 8. The method of any of aspects 2-7, wherein the UE capability set is transmitted jointly with the information set or transmitted separately from the information set.
   Aspect 9. The method of any of aspects 2-8, wherein the receiving the indication is based on the UE capability set, the information set, and a BS-side information set.
   Aspect 10. The method of aspect 9, wherein the BS-side information set comprises at least one of:
an availability for cooperation of the plurality of candidate cooperative UE sets, a discontinuous reception (DRX) configuration of the plurality of candidate cooperative UE sets, a transmit (TX) beam information of the plurality of candidate cooperative UE sets, a TX beam separation of the plurality of candidate cooperative UE sets, a transmission/reception point (TRP) information, or a BS sensing result of the plurality of candidate cooperative UE sets.
   Aspect 11. The method of aspect 10, wherein the TRP information comprises at least one of:
an on/off status, or
an inter-TRP link quality.
   Aspect 12. The method of any of aspects 2-11, further comprising:
gathering, by the UE, information in the information set before UE cooperation is enabled.
   Aspect 13. The method of any of aspects 1-12, wherein the receiving the indication is by a radio resource control (RRC) configuration message.
   Aspect 14. A method of wireless communication comprising:
receiving, by a base station (BS) from a user equipment (UE), a cooperative UE update request comprising a plurality of candidate cooperative UE sets and a UE capability set associated with the plurality of candidate cooperative UE sets;
transmitting, by the BS to the UE, an indication of a cooperative UE set comprising at least one of the plurality of candidate cooperative UE sets based on the UE capability set and a BS-side information set; and
communicating, by the BS, using the cooperative UE set.
   Aspect 15. The method of aspect 14, wherein the cooperative UE update request further comprises an information set associated with a plurality of candidate cooperative UEs in the plurality of candidate cooperative UE sets.
   Aspect 16. The method of aspect 15, wherein the information set comprises at least one of:
a sidelink channel information of the plurality of candidate cooperative UEs, a UE location information of the plurality of candidate cooperative UEs, or a channel measurement information of the plurality of candidate cooperative UEs.
   Aspect 17. The method of aspect 16, wherein the UE capability set comprises at least one of:
a multiple transmission and reception (multi-TRP) capability, or
a multiple downlink control information (multi-DCI) capability.
   Aspect 18. The method of any of aspects 16-17, wherein the channel measurement information comprises a downlink (DL) measurement of a broadcast channel.
   Aspect 19. The method of any of aspects 16-18, wherein the channel measurement information comprises a downlink (DL) measurement of a unicast UE channel.
   Aspect 20. The method of any of aspects 16-19, wherein the sidelink channel information comprises a link latency.
   Aspect 21. The method of any of aspects 16-20, wherein the information set further comprises at least one of:
a preferred synchronization signal block (SSB) index of the plurality of candidate cooperative UEs,
a physical cell ID (PCI) of the plurality of candidate cooperative UEs,
a layer 1 (L1) reference signal received power (RSRP) of the plurality of candidate cooperative UEs, or
a layer 3 (L3) RSRP of the plurality of candidate cooperative UEs.
   Aspect 22. The method of any of aspects 15-21, wherein the UE capability set is transmitted jointly with the information set or separately from the information set.
   Aspect 23. The method of any of aspects 14-22, wherein the BS-side information set comprises at least one of:
an availability for cooperation of the plurality of candidate cooperative UE sets, a discontinuous reception (DRX) configuration of the plurality of candidate cooperative UE sets, a transmit (TX) beam information of the plurality of candidate cooperative UE sets, a TX beam separation of the plurality of candidate cooperative UE sets, a transmission/reception point information, or a BS sensing result of the plurality of candidate cooperative UE sets.
   Aspect 24. The method of aspect 23, wherein the transmission/reception point (TRP) information comprises at least one of:
an on/off status, or
an inter-transmission/reception point link quality.
   Aspect 25. The method of any of aspects 14-24, wherein the transmitting the indication is by a radio resource control (RRC) configuration message.
   Aspect 26. A method of wireless communication comprising:
transmitting, by a user equipment (UE) to a base station (BS), a cooperative UE update request comprising an indication of a plurality of candidate cooperative UE sets;
receiving, by the UE from the BS, a request for measurements associated with the plurality of candidate cooperative UE sets in response to the cooperative UE update request;
transmitting, by the UE to the BS, the measurements associated with the plurality of candidate cooperative UE sets; and
receiving, by the UE from the BS, an indication of a cooperative UE set comprising at least one of the plurality of candidate cooperative UE sets based on the measurements.
   Aspect 27. The method of aspect 26, further comprising:
connecting, by the UE via a sidelink channel, to a cooperative UE associated with the cooperative UE set; and
communicating, by the UE with the BS, using the cooperative UE set.
   Aspect 28. The method of any of aspects 26-27, further comprising:
receiving channel state information reference signal (CSI-RS) measurement reports from a plurality of candidate cooperative UEs indicated in the plurality of candidate cooperative UE sets;
wherein the measurements comprise the CSI-RS measurement reports.
   Aspect 29. The method of any of aspects 26-28, further comprising:
performing a random access channel (RACH) measurement; and
wherein the measurements comprises the RACH measurement.
   Aspect 30. The method of any of aspects 26-29, wherein the transmitting the cooperative UE update request further comprises:
transmitting, by the UE to the BS, a UE capability set associated with the plurality of candidate cooperative UE sets and an information set associated with a plurality of candidate cooperative UEs in the plurality of candidate cooperative UE sets.
   Aspect 31. The method of aspect 30, wherein the information set comprises at least one of:
a sidelink channel information of the plurality of candidate cooperative UEs, a UE location information of the plurality of candidate cooperative UEs, or a channel measurement information of the plurality of candidate cooperative UEs.
   Aspect 32. The method of aspect 31, wherein the UE capability set comprises at least one of:
a multiple transmission and reception (multi-TRP) capability, or
a multiple downlink control information (multi-DCI) capability.
   Aspect 33. The method of any of aspects 31-32, wherein the channel measurement information comprises at least one of:
a downlink (DL) measurement of a broadcast channel, or
a DL measurement of a unicast UE channel.
   Aspect 34. The method of any of aspects 31-33, wherein the sidelink channel information comprises a link latency.
   Aspect 35. The method of any of aspects 31-34, wherein the information set further comprises at least one of:
a preferred synchronization signal block (SSB) index of the plurality of candidate cooperative UEs,
a physical cell ID (PCI) of the plurality of candidate cooperative UEs,
a layer 1 (L1) reference signal received power (RSRP) of the plurality of candidate cooperative UEs, or
a layer 3 (L3) RSRP of the plurality of candidate cooperative UEs.
   Aspect 36. The method of any of aspects 25-35, wherein the UE capability set is transmitted jointly with the information set or separately from the information set.
   Aspect 37. The method of any of aspects 25-36, wherein the receiving the indication is further based on the UE capability set, the information set, and a BS-side information set.
   Aspect 38. The method of aspect 37, wherein the BS-side information set comprises at least one of:
an availability for cooperation of the plurality of candidate cooperative UEs, a discontinuous reception (DRX) configuration of the plurality of candidate cooperative UEs, a transmit (TX) beam information of the plurality of candidate cooperative UEs, a TX beam separation of the plurality of candidate cooperative UEs, a transmission/reception point information, or a BS sensing result of the plurality of candidate cooperative UEs.
   Aspect 39. The method of aspect 38, wherein the transmission/reception point information comprises at least one of:
an on/off status, or
an inter-transmission/reception point link quality.
   Aspect 40. A method of wireless communication comprising:
receiving, by a base station (BS) from a user equipment (UE), a cooperative UE update request comprising and indication of a plurality of candidate cooperative UE sets;
transmitting, by the BS, a request for measurements associated with the plurality of candidate cooperative UE sets in response to receiving the cooperate UE update request;
receiving, by the BS, the measurements associated with the plurality of candidate cooperative UE sets; and
transmitting, by the BS to the UE, an indication of a cooperative UE set comprising at least one of the plurality of candidate cooperative UE sets based on the measurements, and a BS-side information set.
   Aspect 41. The method of aspect 40, wherein:
the transmitting the request comprises transmitting the request for measurements to at least one of a plurality of candidate cooperative UEs in the plurality of candidate cooperative UE sets; and
the receiving the measurements comprises receiving the measurements from the at least one of the plurality of candidate cooperative UEs.
   Aspect 42. The method of any of aspects 40-41, wherein:
the transmitting the request comprises transmitting the request for measurements to the UE; and
the receiving the measurements comprises receiving the measurements from the UE.
   Aspect 43. The method of any of aspects 40-42, wherein the BS-side information set comprises at least one of:
transmit (TX) beam information, or
transmission/reception point (TRP) information.
   Aspect 44. The method of any of aspects 65-43, wherein the measurements comprise at least one of:
a channel state information reference signal (CSI-RS) measurement, or
a RACH measurement.
   Aspect 45. The method of any of aspects 40-44, wherein the receiving the cooperative UE update request further comprises:
receiving, by the BS from the UE, a UE capability set associated with the plurality of candidate cooperative UE sets and an information set associated with a plurality of candidate cooperative UEs in the plurality of candidate cooperative UE sets.
   Aspect 46. The method of aspect 45, wherein the information set comprises at least one of:
a sidelink channel information of the plurality of candidate cooperative UEs, a UE location information of the plurality of candidate cooperative UEs, or a channel measurement information of the plurality of candidate cooperative UEs.
   Aspect 47. The method of aspect 46, wherein the UE capability set comprises at least one of:
a multiple transmission and reception (multi-TRP) capability, or
a multiple downlink control information (multi-DCI) capability.
   Aspect 48. The method of any of aspects 46-47, wherein the channel measurement information comprises at least one of:
a downlink (DL) measurement of a broadcast channel, or
a downlink (DL) measurement of a unicast UE channel.
   Aspect 49. The method of any of aspects 46-48, wherein the sidelink channel information comprises a link latency.
   Aspect 50. The method of any of aspects 46-49, wherein the information set further comprises at least one of:
a preferred synchronization signal block (SSB) index of the plurality of candidate cooperative UEs,
a physical cell ID (PCI) of the plurality of candidate cooperative UEs,
a layer 1 (L1) reference signal received power (RSRP) of the plurality of candidate cooperative UEs, or
a layer 3 (L3) RSRP of the plurality of candidate cooperative UEs.
   Aspect 51. The method of any of aspects 45-50, wherein the UE capability set is transmitted jointly with the information set or separately from the information set.
   Aspect 52. The method of any of aspects 45-51, wherein the transmitting the indication is further based on the UE capability set, the information set, and a BS-side information set.
   Aspect 53. The method of aspect 52, wherein the BS-side information set comprises at least one of:
an availability for cooperation of the plurality of candidate cooperative UEs, a discontinuous reception (DRX) configuration of the plurality of candidate cooperative UEs, a transmit (TX) beam information of the plurality of candidate cooperative UEs, a TX beam separation of the plurality of candidate cooperative UEs, a transmission/reception point information, or a BS sensing result of the plurality of candidate cooperative UEs.
   Aspect 54. The method of aspect 53, wherein the transmission/reception point information comprises at least one of:
an on/off status, or
an inter-transmission/reception point link quality.
   Aspect 55. The method of aspect 40 further comprising:
transmitting, by the BS to the first UE, a request for UE capability information; and
receiving, based on the request for UE capability information, UE capability information.
   Aspect 56. An apparatus for wireless communications at a user equipment (UE), comprising:
means for transmitting, to a base station (BS), a cooperative UE update request comprising a plurality of candidate cooperative UE sets and a UE capability set associated with the plurality of candidate cooperative UE sets;
means for receiving, from the BS, an indication of a cooperative UE set comprising at least one of the plurality of candidate cooperative UE sets;
means for connecting, via a sidelink channel, to at least one cooperative UE associated with the cooperative UE set; and
means for communicating, with the BS, using the cooperative UE set.
   Aspect 57. The apparatus of aspect 56, further comprising means for performing the method of any one of aspects 2-13.
   Aspect 58. An apparatus for wireless communications at a base station (BS), comprising:
means for receiving, from a user equipment (UE), a cooperative UE update request comprising a plurality of candidate cooperative UE sets and a UE capability set associated with the plurality of candidate cooperative UE sets;
means for transmitting, to the UE, an indication of a cooperative UE set comprising at least one of the plurality of candidate cooperative UE sets based on the UE capability set and a BS-side information set; and
means for communicating using the cooperative UE set.
   Aspect 59. The apparatus of aspect 58, further comprising means for performing the method of any one of aspects 15-25.
   Aspect 60. An apparatus for wireless communications at a user equipment (UE), comprising:
means for transmitting, to a base station (BS), a cooperative UE update request comprising an indication of a plurality of candidate cooperative UE sets;
means for receiving, from the BS, a request for measurements associated with the plurality of candidate cooperative UE sets in response to the cooperative UE update request;
means for transmitting, to the BS, the measurements associated with the plurality of candidate cooperative UE sets; and
means for receiving, from the BS, an indication of a cooperative UE set comprising at least one of the plurality of candidate cooperative UE sets based on the measurements.
   Aspect 61. The apparatus of aspect 60, further comprising means for performing the method of any one of aspects 27-39.
   Aspect 62. An apparatus for wireless communications at a base station (BS), comprising:
means for receiving, from a user equipment (UE), a cooperative UE update request comprising and indication of a plurality of candidate cooperative UE sets;
means for transmitting a request for measurements associated with the plurality of candidate cooperative UE sets in response to receiving the cooperate UE update request; and
means for receiving the measurements associated with the plurality of candidate cooperative UE sets; and
means for transmitting, to the UE, an indication of a cooperative UE set comprising at least one of the plurality of candidate cooperative UE sets based on the measurements, and a BS-side information set.
   Aspect 63. The apparatus of aspect 62, further comprising means for performing the method of any one of aspects 41-55.
   Aspect 64. A non-transitory computer-readable medium storing instructions which, when executed by a computer, cause the computer to carry out:
transmitting, by a user equipment (UE) to a base station (BS), a cooperative UE update request comprising a plurality of candidate cooperative UE sets and a UE capability set associated with the plurality of candidate cooperative UE sets;
receiving, by the UE from the BS, an indication of a cooperative UE set comprising at least one of the plurality of candidate cooperative UE sets;
connecting, by the UE via a sidelink channel, to at least one cooperative UE associated with the cooperative UE set; and
communicating, by the UE with the BS, using the cooperative UE set.
   Aspect 65. The non-transitory computer-readable medium of aspect 64, further comprising the instructions executable to perform the method of any one of aspects 2-13.
   Aspect 66. A non-transitory computer-readable medium storing instructions which, when executed by a computer, cause the computer to carry out:
receiving, by a base station (BS) from a user equipment (UE), a cooperative UE update request comprising a plurality of candidate cooperative UE sets and a UE capability set associated with the plurality of candidate cooperative UE sets;
transmitting, by the BS to the UE, an indication of a cooperative UE set comprising at least one of the plurality of candidate cooperative UE sets based on the UE capability set and a BS-side information set; and
communicating, by the BS, using the cooperative UE set.
   Aspect 67. The non-transitory computer-readable medium of aspect 66, further comprising the instructions executable to perform the method of any one of aspects 15-25.
   Aspect 68. A non-transitory computer-readable medium storing instructions which, when executed by a computer, cause the computer to carry out:
transmitting, by a user equipment (UE) to a base station (BS), a cooperative UE update request comprising an indication of a plurality of candidate cooperative UE sets;
receiving, by the UE from the BS, a request for measurements associated with the plurality of candidate cooperative UE sets in response to the cooperative UE update request;
transmitting, by the UE to the BS, the measurements associated with the plurality of candidate cooperative UE sets; and
receiving, by the UE from the BS, an indication of a cooperative UE set comprising at least one of the plurality of candidate cooperative UE sets based on the measurements.
   Aspect 69. The non-transitory computer-readable medium of aspect 68, further comprising the instructions executable to perform the method of any one of aspects 27-39.
   Aspect 70. A non-transitory computer-readable medium storing instructions which, when executed by a computer, cause the computer to carry out:
receiving, by a base station (BS) from a user equipment (UE), a cooperative UE update request comprising and indication of a plurality of candidate cooperative UE sets;
transmitting, by the BS, a request for measurements associated with the plurality of candidate cooperative UE sets in response to receiving the cooperate UE update request;
receiving, by the BS, the measurements associated with the plurality of candidate cooperative UE sets; and
transmitting, by the BS to the UE, an indication of a cooperative UE set comprising at least one of the plurality of candidate cooperative UE sets based on the measurements, and a BS-side information set.
   Aspect 71. The non-transitory computer-readable medium of aspect 70, further comprising the instructions executable to perform the method of any one of aspects 41-55.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C). The terms “about” or “approximately” may be used to denote a range of +/−2%, unless specified otherwise.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

1. A user equipment (UE) comprising:
a transceiver configured to:
transmit, to a base station (BS), a cooperative UE update request comprising a plurality of candidate cooperative UE sets and a UE capability set associated with the plurality of candidate cooperative UE sets; and
receive, from the BS, an indication of a cooperative UE set comprising at least one of the plurality of candidate cooperative UE sets; and
a processor configured to connect, via a sidelink channel, to at least one cooperative UE associated with the cooperative UE set,
wherein the transceiver is further configured to communicate, with the BS, using the cooperative UE set.

2. The UE of claim 1, wherein the cooperative UE update request further comprises an information set associated with a plurality of candidate cooperative UEs in the plurality of candidate cooperative UE sets.

3. The UE of claim 2, wherein the information set comprises at least one of:
a sidelink channel information of the plurality of candidate cooperative UEs,
a UE location information of the plurality of candidate cooperative UEs, or
a channel measurement information of the plurality of candidate cooperative UEs.

4. The UE of claim 1, wherein the UE capability set comprises at least one of:
a multiple transmission/reception point (multi-TRP) capability, or
a multiple downlink control information (multi-DCI) capability.

5. The UE of claim 3, wherein the channel measurement information comprises at least one of:
a downlink (DL) measurement of a broadcast channel, or
a downlink (DL) measurement of a unicast UE channel.

6. The UE of claim 3, wherein the sidelink channel information comprises a link latency.

7. The UE of claim 3, wherein the information set further comprises at least one of:
a preferred synchronization signal block (SSB) index of the plurality of candidate cooperative UEs,
a physical cell ID (PCI) of the plurality of candidate cooperative UEs,
a layer 1 (L1) reference signal received power (RSRP) of the plurality of candidate cooperative UEs, or
a layer 3 (L3) RSRP of the plurality of candidate cooperative UEs.

8. The UE of claim 2, wherein the UE capability set is transmitted jointly with the information set or transmitted separately from the information set.

9. The UE of claim 2, wherein the receiving the indication is based on the UE capability set, the information set, and a BS-side information set.

10. The UE of claim 9, wherein the BS-side information set comprises at least one of:
an availability for cooperation of the plurality of candidate cooperative UE sets,
a discontinuous reception (DRX) configuration of the plurality of candidate cooperative UE sets,
a transmit (TX) beam information of the plurality of candidate cooperative UE sets,
a TX beam separation of the plurality of candidate cooperative UE sets,
a transmission/reception point (TRP) information, or
a BS sensing result of the plurality of candidate cooperative UE sets.

11. The UE of claim 10, wherein the TRP information comprises at least one of:
an on/off status, or
an inter-TRP link quality.

12. The UE of claim 2, wherein the processor is further configured to:
gather information in the information set before UE cooperation is enabled.

13. The UE of claim 1, wherein the transceiver is configured to receive the indication by a radio resource control (RRC) configuration message.

14. A base station (BS) comprising:
a transceiver configured to:
receive, from a user equipment (UE), a cooperative UE update request comprising a plurality of candidate cooperative UE sets and a UE capability set associated with the plurality of candidate cooperative UE sets;
transmit, to the UE, an indication of a cooperative UE set comprising at least one of the plurality of candidate cooperative UE sets based on the UE capability set and a BS-side information set; and
communicate using the cooperative UE set.

15. The BS of claim 14, wherein the cooperative UE update request further comprises an information set associated with a plurality of candidate cooperative UEs in the plurality of candidate cooperative UE sets.

16. The BS of claim 15, wherein the information set comprises at least one of:
a sidelink channel information of the plurality of candidate cooperative UEs,
a UE location information of the plurality of candidate cooperative UEs, or
a channel measurement information of the plurality of candidate cooperative UEs.

17. The BS of claim 16, wherein the UE capability set comprises at least one of:
a multiple transmission and reception (multi-TRP) capability, or
a multiple downlink control information (multi-DCI) capability.

18. The BS of claim 16, wherein the channel measurement information comprises a downlink (DL) measurement of a broadcast channel.

19. The BS of claim 16, wherein the channel measurement information comprises a downlink (DL) measurement of a unicast UE channel.

20. The BS of claim 16, wherein the sidelink channel information comprises a link latency.

21. The BS of claim 16, wherein the information set further comprises at least one of:
a preferred synchronization signal block (SSB) index of the plurality of candidate cooperative UEs,
a physical cell ID (PCI) of the plurality of candidate cooperative UEs,
a layer 1 (L1) reference signal received power (RSRP) of the plurality of candidate cooperative UEs, or
a layer 3 (L3) RSRP of the plurality of candidate cooperative UEs.

22. The BS of claim 15, wherein the transceiver is configured to receive the UE capability set jointly with the information set or separately from the information set.

23. The BS of claim 14, wherein the BS-side information set comprises at least one of:
an availability for cooperation of the plurality of candidate cooperative UE sets,
a discontinuous reception (DRX) configuration of the plurality of candidate cooperative UE sets,
a transmit (TX) beam information of the plurality of candidate cooperative UE sets,
a TX beam separation of the plurality of candidate cooperative UE sets,
a transmission/reception point information, or
a BS sensing result of the plurality of candidate cooperative UE sets.

24. The BS of claim 23, wherein the transmission/reception point (TRP) information comprises at least one of:
an on/off status, or
an inter-transmission/reception point link quality.

25. The BS of claim 14, wherein the transceiver is configured to transmit the indication by a radio resource control (RRC) configuration message.

26. A method of wireless communication comprising:
transmitting, by a user equipment (UE) to a base station (BS), a cooperative UE update request comprising a plurality of candidate cooperative UE sets and a UE capability set associated with the plurality of candidate cooperative UE sets;
receiving, by the UE from the BS, an indication of a cooperative UE set comprising at least one of the plurality of candidate cooperative UE sets;
connecting, by the UE via a sidelink channel, to at least one cooperative UE associated with the cooperative UE set; and
communicating, by the UE with the BS, using the cooperative UE set.

27. The method of claim 26, wherein the cooperative UE update request further comprises an information set associated with a plurality of candidate cooperative UEs in the plurality of candidate cooperative UE sets;
wherein the information set comprises at least one of:
a sidelink channel information of the plurality of candidate cooperative UEs,
a UE location information of the plurality of candidate cooperative UEs, or
a channel measurement information of the plurality of candidate cooperative UEs; and
wherein the UE capability set comprises at least one of:
a multiple transmission/reception point (multi-TRP) capability, or
a multiple downlink control information (multi-DCI) capability.

28. The method of claim 27, further comprising:
gathering, by the UE, information in the information set before UE cooperation is enabled.

29. A method of wireless communication comprising:
receiving, by a base station (BS) from a user equipment (UE), a cooperative UE update request comprising a plurality of candidate cooperative UE sets and a UE capability set associated with the plurality of candidate cooperative UE sets;
transmitting, by the BS to the UE, an indication of a cooperative UE set comprising at least one of the plurality of candidate cooperative UE sets based on the UE capability set and a BS-side information set; and
communicating, by the BS, using the cooperative UE set.

30. The method of claim 29, further comprising:
transmitting, by the BS to the first UE, a request for UE capability information; and
receiving, based on the request for UE capability information, UE capability information.
